(19) United States
(12) Patent Application Publication
(10) Pub. No.: US 2025/0203557 A1
(43) Pub. Date: Jun. 19, 2025

(54) SATELLITE-ASSISTED USER EQUIPMENT (UE) LOCATION TECHNIQUES

(71) Applicant: Intel Corporation, Santa Clara, CA (US)

(72) Inventors: Stephen T. Palermo, Chandler, AZ (US); Valerie J. Parker, Portland, OR (US)

(21) Appl. No.: 18/846,948

(22) PCT Filed: Mar. 17, 2023
(86) PCT No.: PCT/US2023/015512

§ 371 Date: Sep. 13, 2024

Related U.S. Application Data
(60) Provisional application No. 63/321,562, filed on Mar. 18, 2022.
(60) Provisional application No. 63/338,744, filed on May 5, 2022.
(60) Provisional application No. 63/426,638, filed on Nov. 18, 2022.

(51) Int. Cl. H04W 64/00; H04L 5/00; H04W 84/06

(52) U.S. Cl. CPC H04W 64/00; H04L 5/0051; H04W 84/06

(57) ABSTRACT

Various approaches for the generation and verification of user equipment (UE) location, using communications and processing capabilities of non-geostationary (NGSO) satellite networks and equipment are discussed. Among other examples, communications between a UE and a low-earth orbit (LEO) satellite may be used to substantiate or corroborate, to a location management function (LMF) of a 5G network, that a UE is located in or at a particular geographical location or area. Additionally, based on this location information and related SV ephemeris data, a satellite coverage area may be determined for a UE at a location at any one moment in time, for coordinating and managing connectivity of the UE with terrestrial and non-terrestrial networks.

### PRIORITY CLAIM

This application claims the benefit of priority to: U.S. Provisional Patent Application No. 63/321,562, filed Mar. 18, 2022, and titled “SATELLITE NETWORK VERIFIED USER EQUIPMENT (UE) LOCATION TECHNIQUES”; U.S. Provisional Patent Application No. 63/338,744, filed May 5, 2022, and titled “SATELLITE NETWORK VERIFIED USER EQUIPMENT (UE) LOCATION TECHNIQUES”; and U.S. Provisional Patent Application No. 63/426,638, filed Nov. 18, 2022, and titled “SATELLITE-ASSISTED AND ORBIT-VERIFIED USER EQUIPMENT (UE) LOCATION TECHNIQUES”; each of which is incorporated herein by reference in their entirety.

### TECHNICAL FIELD

Embodiments described herein generally relate to network communication scenarios, including mobility, power consumption management, connectivity coordination, location identification, and location verification techniques involving terrestrial (e.g., 5G cellular) and non-terrestrial (e.g., Low-Earth Orbit (LEO) satellite) networks.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates network connectivity in non-terrestrial (satellite) and terrestrial (e.g., mobile cellular network) settings, according to an example;

FIG. 2 illustrates terrestrial communication and architecture details in a low Earth orbit (LEO) satellite communication network, according to an example;

FIG. 3 illustrates a network connectivity ecosystem implementing a LEO satellite communication network, according to an example;

FIG. 4 illustrates an overview of terrestrial-based, LEO satellite-enabled edge processing, according to an example;

FIG. 5 illustrates a scenario of geographic satellite connectivity from LEO satellite communication networks, according to an example;

FIGS. 6A and 6B illustrate terrestrial-based, LEO satellite-enabled edge processing arrangements, according to an example;

FIG. 7 illustrates an arrangement for processing the location of a terrestrial-based user equipment (UE) with use of a non-terrestrial network, according to an example;

FIG. 8 illustrates a workflow for communicating location-related measurements in connection with a non-terrestrial assisted location measurement function, according to an example;

FIG. 9 illustrates a flowchart of a method of implementing non-terrestrial assisted location verification, according to an example;

FIG. 10A, FIG. 10B, and FIG. 10C illustrate respective configurations of non-terrestrial and 5G network architectures, according to an example;

FIG. 11A and FIG. 11B illustrate examples of mobility management based on non-terrestrial network coverage information and verified location, according to an example;

FIG. 12 illustrates a flowchart of a method of implementing mobility management based on non-terrestrial coverage, according to an example;

FIG. 13 illustrates a scenario for determining Time Difference of Arrival (TDoA) from a non-terrestrial network, according to an example;

FIG. 14A and FIG. 14B illustrate scenarios of determining a timing advance between a UE and a gNB network, according to an example;

FIG. 15A and FIG. 15B illustrate approaches for determining an uplink TDoA, according to an example;

FIG. 16 illustrates a flowchart of a method for calculating a UE UL-TDoA with a non-terrestrial network, according to an example;

FIG. 17 illustrates a flow diagram of operations for a multicast round trip time (mRTT) location calculation, according to an example;

FIG. 18 illustrates a flowchart of a method of non-terrestrial-network (NTN)-assisted location calculation and verification for a terrestrial user equipment (UE), according to an example;

FIG. 19 illustrates an overview of an edge cloud configuration for edge computing, according to an example; and

FIG. 20 illustrates a block diagram of example components in a computing device that can operate as a compute processing platform, according to an example.

### DETAILED DESCRIPTION

The following disclosure addresses aspects of location identification and location data processing for identifying and verifying the terrestrial location and geographic coordinates of user equipment (e.g., smartphones, mobile computing devices, and other terrestrial network endpoints). In the following approaches, a network verified UE location can be produced using telemetry and relevant data from non-terrestrial satellites (e.g., satellites of a low-Earth orbit (LEO) constellation) instead of relying exclusively on data from a global navigation satellite system (GNSS) such as the Global Positioning System (GPS). Additionally, in the following approaches, mobility management for UE connectivity is accomplished using this telemetry and relevant data from terrestrial satellites. As a result, network connectivity may be more effectively coordinated between coverage provided by ground-based and satellite-based networks-including, coverage among different satellites of the same satellite constellation, or even among different constellations. Such mobility management for UE connectivity may also provide power saving benefits, to inform UEs at a geographic location whether satellite network coverage is or is not available-so that power is not wasted by the UE attempting a satellite connection when the UE is not located within an available coverage area of a satellite network.

As used herein, a “geographic location” refers to an identifiable position, point, set or range of coordinates, area, region, or territory on or above the Earth-including, in some examples, identifiable with reference to particular land or sea areas, or in airspace above the land or sea areas. The ability to locate a UE at a geographic location may be needed for Non-Terrestrial Networks (NTNs) to support some services and use cases that are subjected to national regulations or other constellation or communication operational constraints (hereinafter “regulated services”). As recognized in 3GPP TR 23.737, the list of such regulated services has been identified to include network features such as: Public Warning System (PWS), Lawful interception (LI), Emergency services (EMS), and Charging and Tariff notifications. Furthermore, 3GPP TR 22.296 has identified that “To support regulated services and features (e.g., Public Warning System, Charging and Billing, Emergency calls, Lawful Intercept, Data Retention Policy in cross-border scenarios and international regions, Network access), 3GPP networks should have the capability to locate each UE in a reliable manner and determine the policy that applies to their operation depending on their location and/or context.”

The following verified network UE location determination approaches overcome current technical limitations, including validity issues with GNSS techniques. GNSS techniques may not be fully trusted by network operators because of jamming and/or spoofing issues. Further, a location method which relies solely on UE-generated location information is unlikely to be considered reliable for network selection purposes. Therefore, a method such as GNSS may not be considered as reliable or trusted unless the information provided by the UE can be verified by the network.

The following approaches provide a framework for the receipt of location-determination information from low-Earth orbit (LEO) non-terrestrial satellites. As is well understood, non-geostationary orbit (NGSO) satellites such as operated in LEO constellations can provide a signal strength that is up to 30 dB stronger than geostationary (GEO) satellite communications used for GNSS. The use of NGSO signals, which are stronger than GNSS, provide enhanced resistance to jamming or spoofing, and a more robust architecture for determining precise location information.

The following approaches also discuss verification of location-related information from NGSO communications, using processing on Earth, to allow consideration of communications with a variety of changing NGSO configurations. For instance, NGSO vehicles may maintain a line of sight with a particular UE for some limited period of time (e.g., up to 10 mins), providing sufficient time to obtain more telemetry to verify signal strengths and thereby location without tampering because the relevant location information is provided directly from a satellite. The following approaches also discuss use cases involving UL-TDoA (Uplink Time Difference of Arrival) to obtain direct reference signals from UE to satellite contact without Earth ground stations, allowing even further opportunities for reduced spoofing and improved security.

The following approaches also discuss various techniques for mobility management of UE connectivity with NGSO vehicles in LEO satellite constellations. As will be understood, a variety of LEO satellite constellation challenges may result in connectivity issues for UEs located on Earth, resulting from issues such as: time varied geometry of a moving satellite constellation, network demands, orbital shifts, and Earth's orbit. Different LEO satellite constellations also have different types and quantities of satellite vehicles (SVs), evolving network demands, and need for orbital adjustments. To address these and other mobility and coverage issues, UE coverage conditions may be identified from associated SV constellation routing data-whether UE connectivity is ultimately achieved from the NTN using inter-satellite links (ISLs) or SV traversal (orbiting) techniques. Such coverage conditions may be considered and used by the UE (and by network resources) to maintain and coordinate connectivity of dual-mode UEs with terrestrial networks (TNs) and NTNs, and to optimize the use of network resources for best performance. Such optimization may help to achieve low latency objectives, optimize power usage, and maintain availability to appropriate network/compute processing resources.

### Overview of Non-Terrestrial Network Configurations

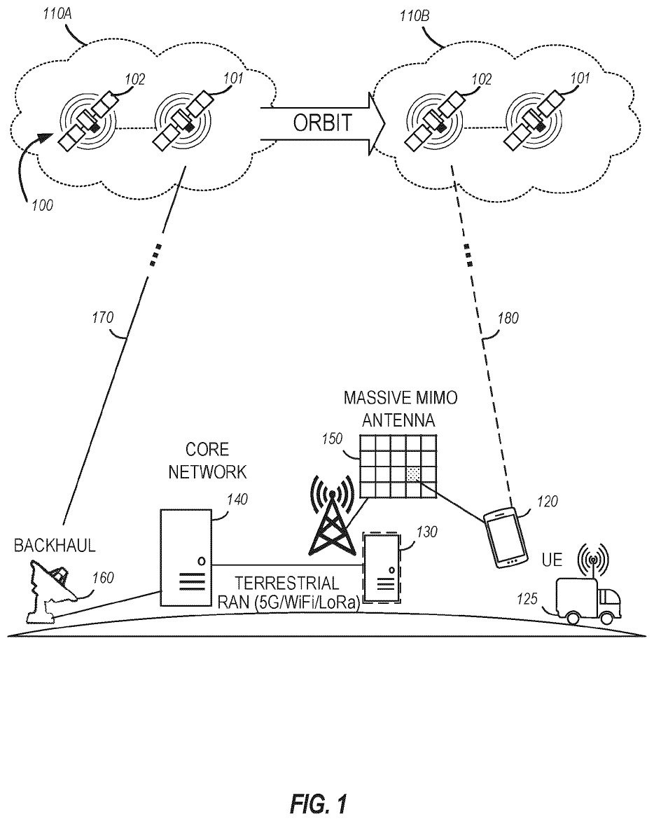

FIG. 1 illustrates network connectivity in non-terrestrial (satellite) and terrestrial (e.g., mobile cellular network) settings, according to an example. As shown, a satellite constellation 100 (the constellation depicted in FIG. 1 at orbital positions 110A and 110B) may include multiple satellite vehicles (SVs) 101, 102, which are connected to each other and to one or more terrestrial networks. The individual satellites in the constellation 100 (each, an SV) conduct an orbit around the Earth, at an orbit speed that increases as the SV is closer to Earth. LEO constellations are generally considered to include SVs that orbit at an altitude between 160 and 1000 km; at this altitude, each SV orbits the Earth about every 90 to 120 minutes.

The constellation 100 includes individual SVs 101, 102 (and numerous other SVs not shown), and uses multiple SVs to provide communications coverage to a geographic area on Earth. The constellation 100 may also coordinate with other satellite constellations (not shown), and with terrestrial-based networks, to selectively provide connectivity and services for individual devices (user equipment) or terrestrial network systems (network equipment).

In this example, the satellite constellation 100 is connected via a satellite link 170 to a backhaul network 160, which is in turn connected to a 5G core network 140. The 5G core network 140 is used to support 5G communication operations with the satellite network and at a terrestrial 5G radio access network (RAN) 130. For instance, the 5G core network 140 may be located in a remote location, and use the satellite constellation 100 as the exclusive mechanism to reach wide area networks and the Internet. In other scenarios, the 5G core network 140 may use the satellite constellation 100 as a redundant link to access the wide area networks and the Internet; in still other scenarios, the 5G core network 140 may use the satellite constellation 100 as an alternate path to access the wide area networks and the Internet (e.g., to communicate with networks on other continents).

FIG. 1 additionally depicts the use of the terrestrial 5G RAN 130, to provide radio connectivity to a user equipment (UE) such as user device 120 or vehicle 125 on-ground via a massive MIMO antenna 150. It will be understood that a variety of 5G and other network communication components and units are not depicted in FIG. 1 for purposes of simplicity. In some examples, each UE 120 or 125 also may have its own satellite connectivity hardware (e.g., receiver circuitry and antenna), to directly connect with the satellite constellation 100 via satellite link 180. Although a 5G network setting is depicted and discussed at length in the following sections, it will be apparent that other variations of 3GPP, O-RAN, and other network specifications may also be applicable.

Other permutations (not shown) may involve a direct connection of the 5G RAN 130 to the satellite constellation 100 (e.g., with the 5G core network 140 accessible over a satellite link); coordination with other wired (e.g., fiber), laser or optical, and wireless links and backhaul; multi-access radios among the UE, the RAN, and other UEs; and other permutations of terrestrial and non-terrestrial connectivity. Satellite network connections may be coordinated with 5G network equipment and user equipment based on satellite orbit coverage, available network services and equipment, cost and security, and geographic or geopolitical considerations, and the like. With these basic entities in mind, and with the changing compositions of mobile users and in-orbit satellites, the following techniques describe ways in which terrestrial and satellite networks can be extended for various edge computing scenarios.

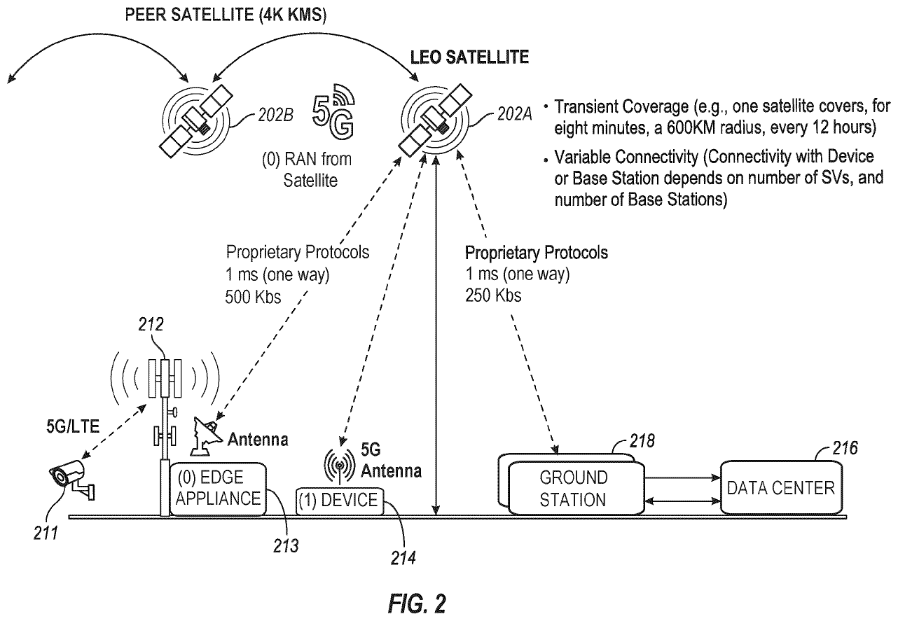

FIG. 2 illustrates terrestrial communication and architecture details in a low Earth orbit satellite communication network, provided by SVs 202A, 202B in a constellation. These drawings depict a variety of connected devices and edge systems, including an IoT device 211, an edge appliance 213, and a device 214. However, the provision of a 5G RAN from SVs 202A, 202B, and the significantly reduced latency from low Earth orbit vehicles, enables much more robust use cases, including the direct connection of devices (device 214) using 5G satellite antennas at the device 214, and communication between the edge appliance 213 and the satellite constellation using proprietary protocols.

As an example, in some LEO settings, one 5G LEO satellite can cover a 500 km radius for 8 minutes, every 12 hours. Connectivity latency to LEO satellites may be as small as one millisecond. Further, connectivity between the satellite constellation and the device 214 or the base station 212 depends on the number and capability of satellite ground stations. In this example, the satellite 201 communicates with a ground station 218 which may host edge computing processing capabilities. The ground station 218 in turn may be connected to a data center 216 for additional processing. With the low latency offered by 5G communications, data processing, compute, and storage may be located at any number of locations (at edge, in satellite, on ground, at core network, at low-latency data center).

Although not shown, an edge appliance may be located on or at the SV 202A. Thus, various edge compute operations may be directly performed using hardware located at the SV, reducing the latency and transmission time that would have been otherwise needed to communicate with the ground station 218 or data center 216. Likewise, in these scenarios, edge compute may be implemented or coordinated among specialized processing circuitry (e.g., FPGAs) or general purpose processing circuitry (e.g., x86 CPUs) located on or at the satellite 201, the ground station 218, the devices 214, other edge appliances not shown, and combinations thereof.

Although not shown in FIG. 2, other types of orbit-based connectivity and edge computing may be involved with these architectures. These include connectivity and compute provided via balloons, drones, dirigibles, and similar types of non-terrestrial elements. Such systems encounter similar temporal limitations and connectivity challenges (like those encountered in a satellite orbit).

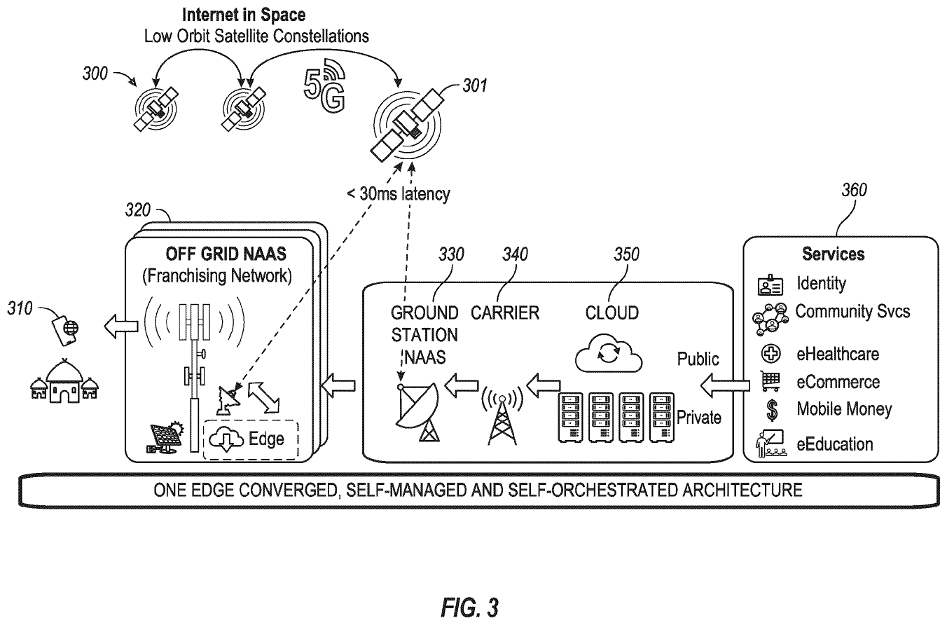

FIG. 3 illustrates a network connectivity ecosystem implementing a satellite communication network. Here, a satellite 301, part of satellite constellation 300, provides coverage to an “off-grid” wireless network 320 (such as a geographically isolated network without wired backhaul). This wireless network 320 in turn provides coverage to individual user equipment 310. Via the satellite connection, a variety of other connections can be made to broader networks and services. These connections include connection to a carrier 340 or to a cloud service 350 via a satellite ground station 330. At the cloud service 350, a variety of public or private services 360 may be hosted. Additionally, with the deployment of edge computing architectures, these services can be moved much closer to the user equipment 310, based on coordination of operations at the network 320, the satellite constellation 300, the ground station 330, or the carrier 340. Such configurations are particularly useful for the connection of industry IoT devices, mobility devices (such as robotaxis, autonomous vehicles), and the overall concept of offering connectivity for “anyone” and “anything.”

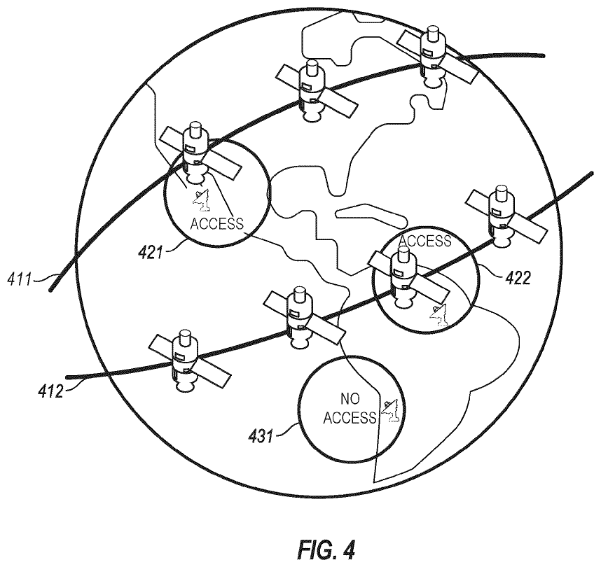

FIG. 4 illustrates an example, simplified scenario of geographic satellite connectivity from multiple LEO satellite communication networks, which depicts the movement of the relevant LEO SVs relative to geographic areas. Here, the orbits 411, 412 of respective satellite constellations operate to provide network coverage in limited geographic areas 421, 422. In contrast, there is no access provided in area 431. It will be understood that the geographic positions of relevant satellite coverage areas may play an important part in determining service characteristics, exclusion or inclusion zones, coordination or mitigation zones, and overall coordination of satellite-ground processing.

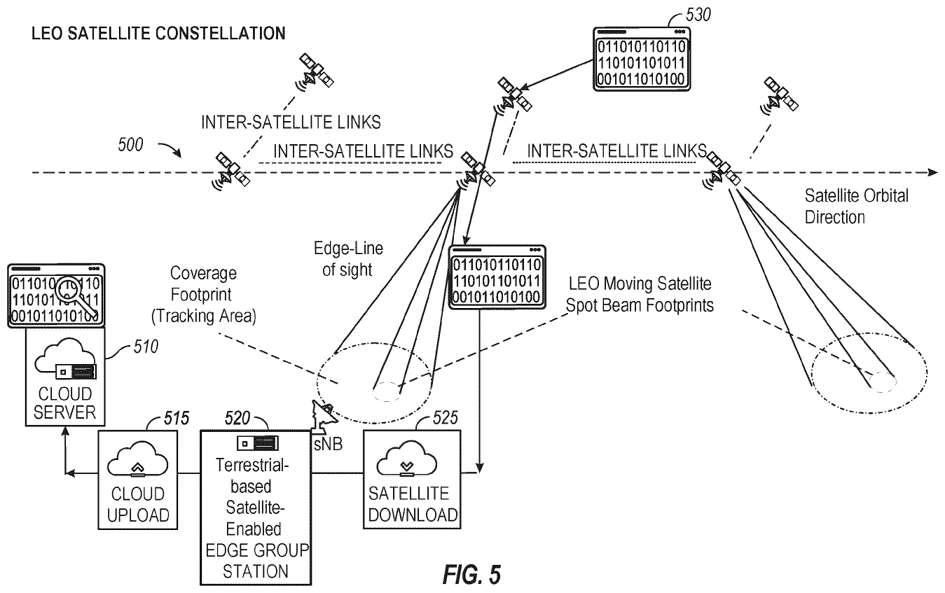

FIG. 5 illustrates an overview of terrestrial-based, satellite-enabled edge processing. As shown, a terrestrial-based, satellite enabled edge ground station (satellite nodeB, sNB) 520 obtains coverage from a satellite constellation 500, and downloads a data set 530. The constellation 500 may coordinate operations to handoff the download using inter-satellite links (such as in a scenario where the data set 530 is streamed, or cannot be fully downloaded before the satellite footprint moves).

The satellite download 525 is provided to the sNB 520 for processing, such as with a cloud upload 515 to a server 510 (e.g., a CDN located at or near the sNB 520). Accordingly, once downloaded to the sNB 520 (and uploaded to the server 510), the user devices located within the terrestrial coverage area (e.g., 5G coverage area) of the sNB 520 now may access the data from the server 510.

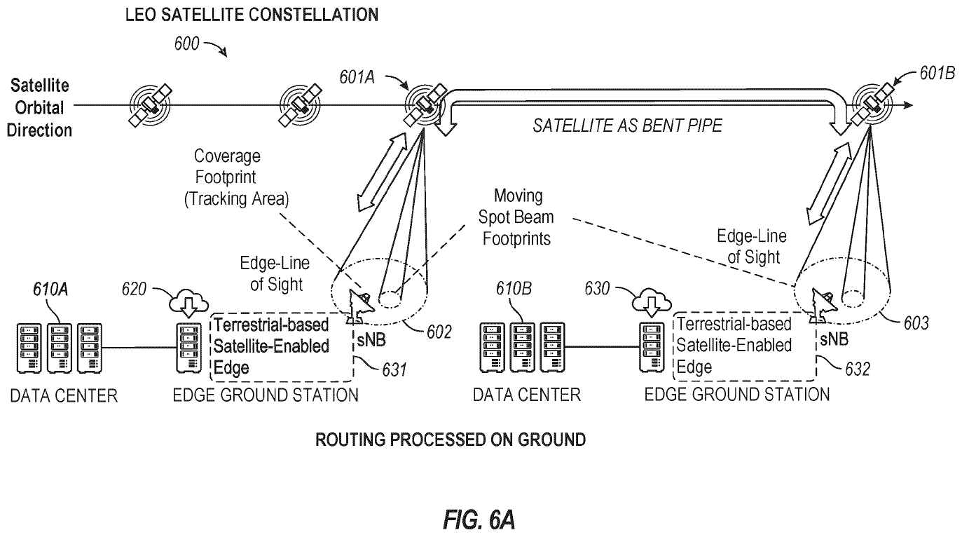

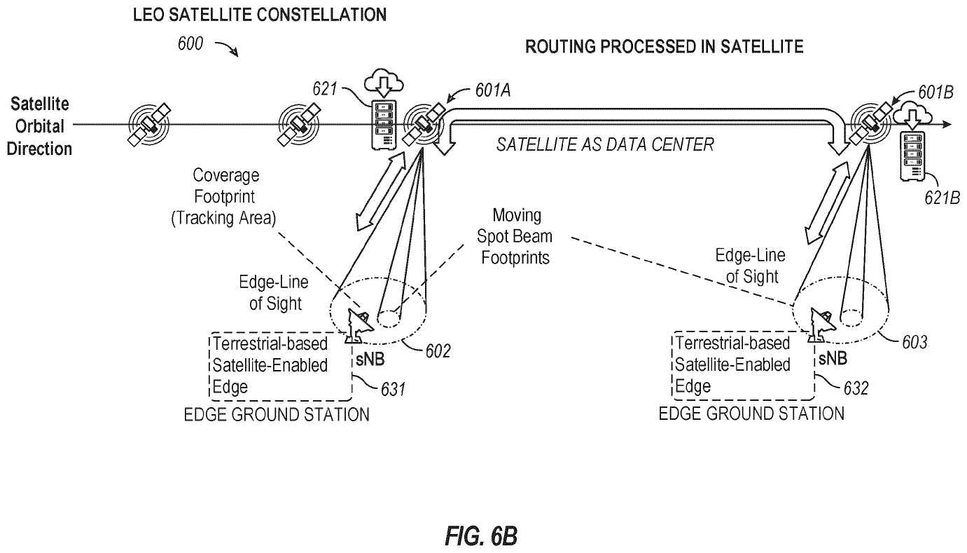

FIG. 6A illustrates a terrestrial-based, satellite-enabled edge processing arrangement, where routing is performed “on-ground” and the satellite is used as a “bent pipe” between edge processing locations. Here, the term “bent pipe” refers to the use of a satellite or satellite constellation as a connection relay, to simply communicate data from one terrestrial location to another terrestrial location. As shown in this figure, a satellite 600 in a constellation has an orbital path, moving from position 601A to 601B, providing separate coverage areas 602 and 603 for connectivity at respective times.

Here, when a satellite-enabled edge computing node 631 (sNB) is in the coverage area 602, it obtains connectivity via the satellite 600 (at position 601A), to communicate with a wider area network. Additionally, this edge computing node sNB 631 may be located at an edge ground station 620 which is also in further communication with a data center 610A, for performing computing operations at a terrestrial location.

Likewise, when a satellite-enabled edge computing node 632 (sNB) is in the coverage area 603, it obtains connectivity via the satellite 600 (at position 601B), to communicate with a wider area network. Again, computing operations (e.g., services, applications, etc.) are processed at a terrestrial location such as edge ground station 630 and data center 610B.

FIG. 6B illustrates another terrestrial-based, satellite-enabled edge processing arrangement. Similar to the arrangement depicted in FIG. 6A, this shows the satellite 600 in a constellation along an orbital path, moving from position 601A to 601B, providing separate coverage areas 602 and 603 at respective times. However, in this example, the satellite is used as a data center, to perform edge computing operations (e.g., serve data, compute data, relay data, etc.).

Specifically, at the satellite vehicle, edge computing hardware 621 is located to process computing or data requests received from the ground station sNBs 631, 632 in the coverage areas 602, 603. This may have the benefit of removing the communication latency involved with another location at the wide area network. However, due to processing and storage constraints, the amount of computation power may be limited at the satellite 600 and thus some requests or operations may be moved to the ground stations 631, 632.

As will be understood, edge computing and edge network connectivity may include various aspects of RAN and software defined networking processing. Specifically, in many of these scenarios, wireless termination may be moved between ground and satellite, depending on available processing resources. Further, in these scenarios, URLLC (ultra-reliable low latency connections) processing may be enabled, based on the configuration of inter-satellite communication links.

### Scenarios for Satellite-Based Location Identification and Corroboration

As noted above, non-terrestrial networks implemented in NGSO systems generally use one of two architecture approaches: (i) a “satellite-as-bent-pipe” architecture, e.g., shown in FIG. 6A, where the line-of-sight satellite vehicle (SV) acts as a repeater that routes signals from UE to the Earth ground station, or similar scenarios where LEO constellations may require SV to SV handoff in the same constellation to reach ground stations; and (ii) an in-orbit “satellite-as-data-center” architecture, e.g., shown in FIG. 6B, where the sNB SV operates as the base station connecting the SV or LEO constellation to the Earth-based core network (CN). Other approaches under exploration also include multi-tiered SV schemes to move the core network functionality into space.

For a bent-pipe architecture, most if not all routing configurations are determined on-Earth based on existing orbits of SVs. SVs in the same orbital band of a constellation, for example, pass over the same point on Earth with different signal intensity, but the signal intensity may be dependent on how high the SV orbit is. The number of SVs and the speed of SVs in that orbital plane also determines the orbital period of fly over at a particular intensity; for instance, a fly over with Iridium® satellites at maximum intensity occurs approximately every 10 minutes. LEO SVs therefore have different intensities over the same point as the SVs move from horizon to direct line-of-sight (LOS) to non-line-of-sight (NLOS). As discussed in the following techniques, intensity thresholds can be used to predict UE contact and verify/predict physical location of a UE, at a particular geographic location.

Bent-pipe architectures for LEO constellations are dependent on SV telemetry, for instance, telemetry indicating the health of the SV itself as provided by battery state and ISL interconnect alignment, as well as SV-to-Earth ground station connection quality at the time of contact. Routing is typically performed on Earth and constellation configurations are set in advance because of the limited capability of processing power on the LEO SVs. In contrast, in-orbit sNB architectures can move some of the same pre-processing in-orbit, but requires LEOs to have more expensive processing capabilities and knowledge of the telemetry health of the constellation. Alternatively, in-orbit sNB architectures can utilize use higher orbit SVs (e.g., in high Earth orbit or high elliptical orbit (HEO), or in geostationary or geosynchronous orbit (GEO)) to provide the core network above the orbital plane of LEOs. Either of these architectural approaches can provide information usable for location verification of terrestrial UE devices.

As discussed herein, information from LEO SV connectivity may be used at a UE to determine, verify, and corroborate location information, based on any number of signal measurements. Such techniques occur in a similar fashion as location techniques used in terrestrial networks. Terrestrial network UEs seek and connect to terrestrial base stations based on signal strength and other UE measurements of signal quality (path loss, fading, etc.). In particular, satellite connected UE positioning can benefit from pre-determined SV “flight plans,” such as with access to corroborating GNSS data, corroborating satellite-enabled terrestrial base station signal strength measurements, and/or actual direct satellite to UE line-of-sight (LOS) intensity expectations. For instance, UE LOS intensity may be measured while in contact with an SV, such as a verified network-based UE position that uses SV LOS intensity level expectations during a specific contact period (e.g., milliseconds to minutes, depending on accuracy and latency need), evaluated with a path-loss-fade equation.

The actual positioning calculation can be performed on-Earth for bent-pipe or in-orbit processing depending on compute resources and any requirements or need for results. For instance, network-verification of a particular location may be provided from validating (and corroborating) any combination of: (1) SV intensity fade expectations, (2) GNSS location data, or (3) telemetry and signal measurements of nearby Earth ground stations in the trajectory of the LOS SV.

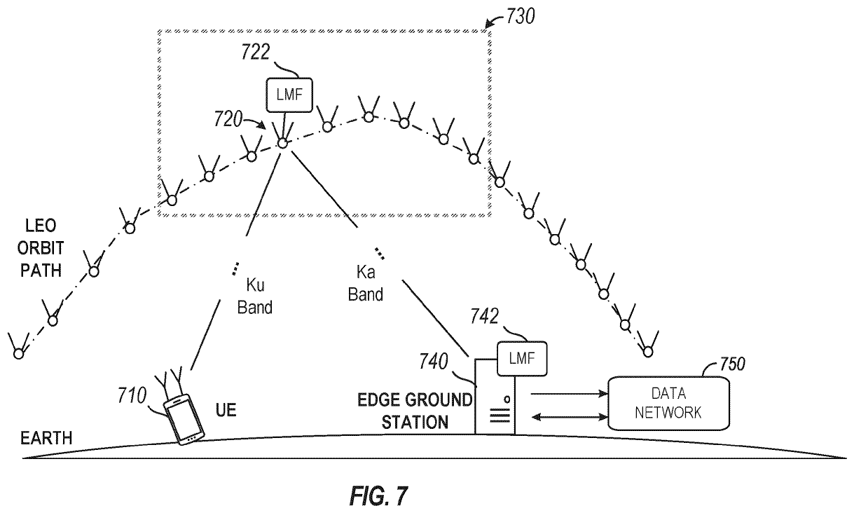

FIG. 7 depicts an arrangement for processing the location of a terrestrial-based user equipment (UE) 710 with use of a non-terrestrial network, provided by a LEO constellation including an SV 720 navigating on a known orbit path. Consistent with the examples above, the UE 710 may communicate to the SV 720 using Ku Band communications; whereas the SV 720 may communicate to an edge ground station 740 using Ka Band communications (although other or multiple communication bands, light communications, etc. may be used). The edge ground station 740 in turn is connected to a data network 750 (e.g., Internet), thus providing connectivity for the UE and the SV to a larger network. The UE 710 may also be connected to a terrestrial 5G base station, not shown, and obtain a connection to the data network 750 or other entities using other pathways.

In this example, the SV 720 operates as an “anchor” SV, to perform signal measurements and calculations when orbiting within line of sight of the UE 710 in an intensity range area 730. The intensity range area 730 may correspond to a particular area in which the SV 720 meets or exceeds a threshold for successful communications (e.g., 55% or higher intensity) between the SV 720 and the UE 710. When in the intensity range area 730, the SV 720 operates to perform location measurement communications with the UE 710, such as to determine the health of the signal, and derive a location status as discussed below.

FIG. 7 notably depicts the orbital path of a single satellite, SV 720, over time at multiple positions. For simplicity, other orbital paths of other satellites in the same and other constellations are not shown. However, it will be understood that other SVs may be located within the intensity range area 730 and available for communication before, after, in lieu of, or in addition to SV 720. The SV 720 may be located in the intensity range area 730 for a short period of time (seconds or minutes), and therefore another SV of the same or different satellites may be designated as the anchor SV for performing location verification communications.

In one example, location management functions may be performed by a location management function (LMF) 722 located at the SV 720, in the LEO constellation, or at another non-terrestrial location. In another example, the location management functions may be performed by an LMF 742 located at the edge ground station 740 or another processing location of the core network or data network 750 (not shown). The orbital path of the SV 720 may be known to the LMF 722, 742, or other entities used by the LMF 722, 742, or may be calculated by the edge ground station 740 or other processing entities (e.g., using orbital calculations to determine real-time orbital positions and coordinates).

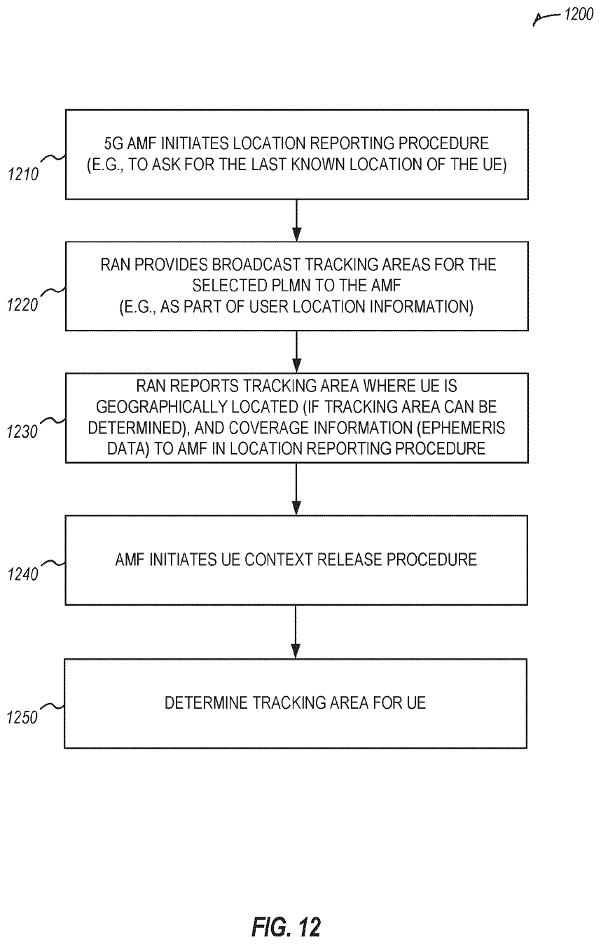

In general, a terrestrial location of UEs may be calculated by measuring the length of time a signal takes to reach a base station gNB such as UL-TDoA using multilateration, round trip time (RTT), and/or acknowledgement of signal information. The receive power signal is typically known by the UE and this value can be compared with the transmit power on the base station so path loss calculations can be performed and the distance between the gNB and the UE estimated (or, verified). Specific examples of calculating UL-TDoA from a non-terrestrial network are discussed below with reference to FIGS. 12 to 14B. Additional examples of using non-terrestrial network information to verify or corroborate UE positioning, further referred to as “Orbit-Verified” location, are also discussed below.

Location of UEs connected to satellite constellations may be calculated using similar functionality and algorithms as implemented in terrestrial networks; however, the calculations also consider the contact or line-of-site downlink at the time of the location request. Latencies and RTT to NTN networks are longer, so satellite-based UL-TDoA algorithms would need to be adjusted accordingly.

Network-verified location techniques in 3GPP networks typically use the LMF component to coordinate which location method is used, and then the LMF component can provide the location result from the location method. However, for low-Earth satellite constellations, satellite computation is limited and may take longer than the line-of site contact available to a UE. In such a scenario, the original satellite would not be available for line-of sight communications, meaning the result would need to be passed from one SV to another (e.g., via inter-satellite links) and downloaded to the ground station. Thus, for ultra-low latency sensitive location results, ground-based compute locations may provide a suitable implementation (e.g., LMFs such as LMF 742), whereas non-latency sensitive calculations can be performed at compute locations in space (e.g., LMFs such as LMF 722). Network-verified location calculations would require some sort of corroboration on the satellite infrastructure (because ground stations can be spoofed) which may require a line of sight contact and telemetry exchange during the request itself, as it may be easier to spoof on the ground than in space.

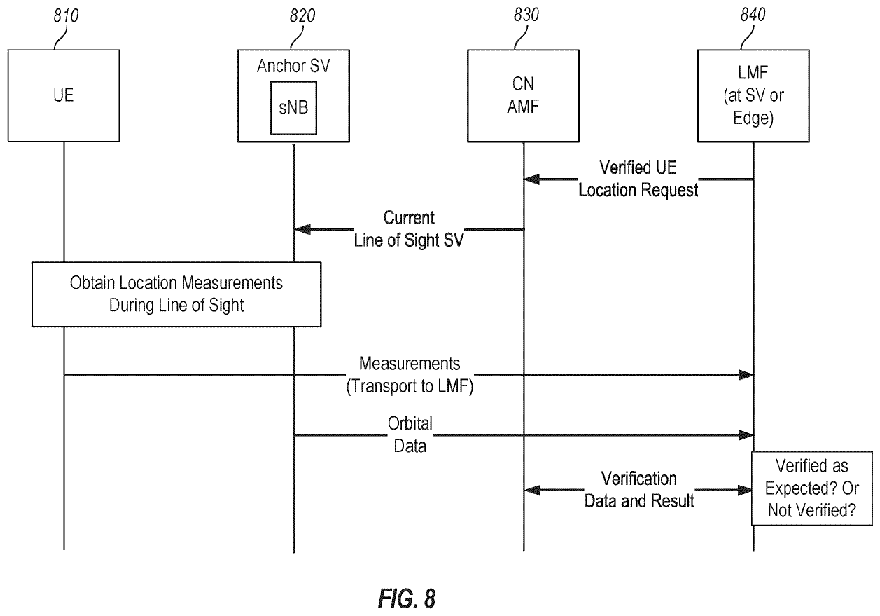

FIG. 8 illustrates a workflow for communicating location-related measurements in connection with a non-terrestrial assisted location measurement function. Here, this workflow is established between a UE 810, SV 820, Core Network (CN) Access and Mobility Management Function (AMF) 830, and LMF 840 located at an SV or terrestrial edge compute location, using the UE 810 to transmit location related measurements as part of a UE-to-NGSO resource grid.

In an example, location-related measurements can be relative to UE and known satellite orbital data (either LEO or GEO orbital data). In another example, location related measurements can be signal strength between the UE and the NGSO satellite(s) currently in line of sight (LOS). In this example, an SV with highest intensity coverage of UE serves as an anchor SV; the anchor SV line of sight with certain intensity is calculated based on orbit ˜1000 km, speed, and location. This is the LOS with the anchor SV and used to exchange location related measurements while in line of sight (LOS) (defined as LOS having access to anchor spot beam >predetermined intensity e.g., 70% or greater). Typically the UE and the anchor SV are available in LOS to the UE for at least a few minutes with high intensity.

Signal strength measurements can include, but are not limited to: RSRQ (reference signal receive quality), sounding reference signal (SRS), time of arrival of signal (TOA), RSRP (reference signal receive power), signal to noise ratios (SNR), path loss, and the like. Location-related measurements are preferred to be between UE and anchor SV to prevent spoofing.

For a bent pipe architecture with no processing capability in the NTN (e.g., as shown in FIG. 6A), the location-related measurements may be securely transmitted to an edge ground station that includes an LMF, such as the LMF 742 depicted in FIG. 7. This LMF may perform processing of location related measurements for UE location result calculations using any available location method (e.g., UL-TDoA, Uplink angle-of-arrival (UL-AoA), multicast RTT (mRTT), GNSS assisted, etc.), as discussed in more detail below.

For an on-board sNB architecture, the LMF calculation may be performed on-board an SV that includes an LMF, such as the LMF 722 depicted in FIG. 7. This LMF may perform processing of location-related measurements for UE location result calculations using any available location method (UL-TDoA, UL-AoA, mRTT, GNSS assisted, etc.), as discussed in more detail below.

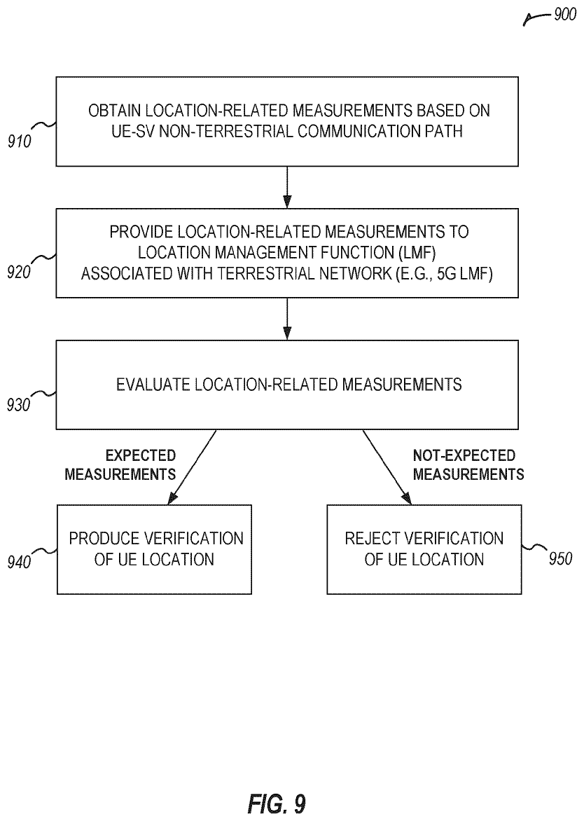

FIG. 9 illustrates a flowchart 900 of an example method of implementing non-terrestrial-network-assisted location measurement verifications. This method may be performed (and repeated) during a line-of-sight communication session with an anchor SV, such as when communications with the anchor SV meet or exceed a minimum signal intensity. The method may be repeated for a particular UE and SV while the SV is in communication range. Further, the method may be adapted based on the use of multiple SVs in communication range, or based on switching from a first SV to a second SV as a respective SV provides reduced signal intensity and moves out of communication range.

The method begins, at operation 910, to obtain location related measurements between a UE and SV, as discussed above. The method continues, at operation 920, to provide the location related measurements to a LMF (such as a LMF of a 5G core network). The method continues, at operation 930, to evaluate expected signal strengths at the LMF, based on the current known orbital data relative to the UE on Earth.

The method continues based on the results of the evaluation of the location data. The method proceeds to operation 940, if the signal strength and location measurements are as expected, as this means a specific UE and specific SV is reasonably situated (e.g., at an expected location) and thereby reaches a “network verified” location state. Alternatively, the method proceeds to operation 950, if the signal strengths and location measurements are not as expected, as this means the location of the UE (and/or the anchor SV) is not network verified.

As will be apparent, a variety of non-terrestrial architecture modifications and processing operations may ensure processing and verification of Satellite-Connected-UE positioning. Thus variation may occur for different satellite architectures in terms of satellite-UE telemetry obtainment, satellite constellation connectivity (especially in the case of varying LEO constellations), satellite capacity to compute precise location results, and availability of corroborating GNSS measurements and or Terrestrial-Based signal quality measurements. Further changes may be implemented to the techniques above, depending on implementation in a Bent-Pipe Architecture, or in a Satellite as a Base Station (sNB) Architecture. Likewise, additional adaptations may be incorporated based on considerations and uses of other forms of GEO and LEO SV constellations.

Additionally, further adaptation of the location identification and verification techniques above may include the use of different and multiple methods (GNSS, and radio access technology (RAT)-dependent methods) to corroborate and verify UE location data. For instance, the network location approaches above may be used to avoid UE false or fake reporting to gain access to unauthorized services. Corroboration of terrestrial and non-terrestrial methods also may be used to verify location in the 5G LMF using combinations of GNSS, LEO with RAT-dependent location methods, and LEO with RAT-independent location methods. This corroboration can provide a flexible architecture that allows satisfaction of location verification requirements for different countries which may allow or restrict different location techniques or RAT network accesses.

Mobility Management enhancement based on SV Constellation Coverage Information and Verified UE Location

As noted above, two significant issues with mobility for UEs connected to NTN networks are caused by discontinuous satellite coverage areas (particularly, due to varying conditions from LEO satellite coverage), and high power consumption (and battery draining issues) at UEs caused from such discontinuous satellite coverage areas. The following provides an approach for UE mobility management in discontinuous Satellite Vehicle (SV) coverage areas, from one or multiple constellations of LEO SVs. Further, the following provides an approach for power saving at NTN-capable UEs, to prevent the waste of power at a UE when the UE is out of network coverage (e.g., so that the UE does not attempt public land mobile network (PLMN), global mobile satellite system (GMSS), or equivalent network access with an SV when there is no NTN coverage).

In an example, a mobility management approach considers the time-varied state of the satellite constellation network for the coverage area, at any point in time. This time-varied state may be determined from the Verified UE Location and Positioning data, discussed above, and other related data values. For instance, verified UE location and positioning data may be obtained using either terrestrial or non-terrestrial methods (e.g., UL-TDoA) via the 5G LMF for the particular AMF serving the particular CN of the service provider's constellation.

As will be understood, constellation SV cell coverage tracking areas (TAs) will vary based on the satellite constellation arrangement, the number of channels per spot beam intensity from an individual SV, and the intensity of signal from an individual SV. Typical service contact flyovers from a LEO SV to a fixed point on Earth is about 10 mins. SVs may have inter-satellite links (ISLs) which can be utilized depending on the NTN UE connection length, as noted above. Further, dynamic changes to constellation and SV coverage may occur due to satellite telemetry changes, maintenance, or other dynamic factors.

LEO SVs typically have limited processing capability due to the high processing cost and limited hardware at an SV. Therefore, most of the network topology routing for the SV is pre-formed and known to a network, prior to supporting actual connections and data throughput. This network topology routing information may be used by a 5G network and at individual UEs to identify the characteristics of the SV tracking areas, to determine when each particular SV is or is not available for connectivity at a particular geographic location.

In addition to network routing information, orbiting information for SVs may be collected and provided to UEs as ephemeris data (e.g., data that provides the assigned places of a satellite at particular time intervals). NTN ephemeris data may provide data values that can be used determine satellite coverage area at any one moment in time, especially for LEO constellations.

SV ephemeris can be used in the 5G network to determine a satellite coverage area (SV coverage area) at any one moment in time, especially for LEO constellations. Thus, an SV ephemeris (orbital and telemetry data) can be used to determine a tracking area, and can be provided to the 5G CN along with UE Location to trigger Release Procedures, and the like.

SV coverage area includes the capability to connect a UE to the NTN network either in transparent or regenerative architecture. LEO satellite constellation challenges include time varied geometry of a moving satellite constellation, network demands, orbital shifts, and Earth's orbit. Different constellations will have different types and quantities of SVs, evolving network demands, and need for orbital adjustments. Constellation SV cell coverage tracking areas will vary based on constellation, the number of channels per spot beam intensity, and intensity of signal.

Relevant SV ephemeris data may be defined to include data from two categories: (1) SV orbital data (e.g., perigee, apogee, inclination, period, semi major access) and (2) SV telemetry data (e.g., uplink/downlink status, inter satellite link status, battery status, temperature status, processing status, speed, altitude sensor, velocity sensor, thruster fuel status, spot beam status, spot beam frequency status, on-board memory status, on-board network packet status, such as the number of packets dropped, processed, malformed, retransmitted, etc.). For example, SV ephemeris data may be leveraged to provide seamless integration of terrestrial and non-terrestrial network connections using dual-mode (LEO satellite and cellular) NTN-capable UEs, supporting a variety of architectures. For instance, such data may be used to inform a UE which mode to begin or end, and whether NTN coverage is possible or not possible.

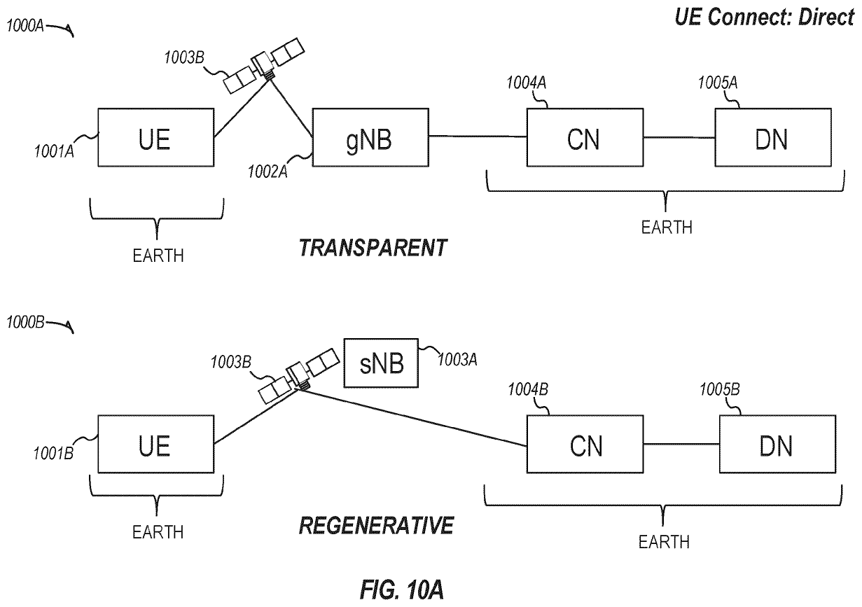

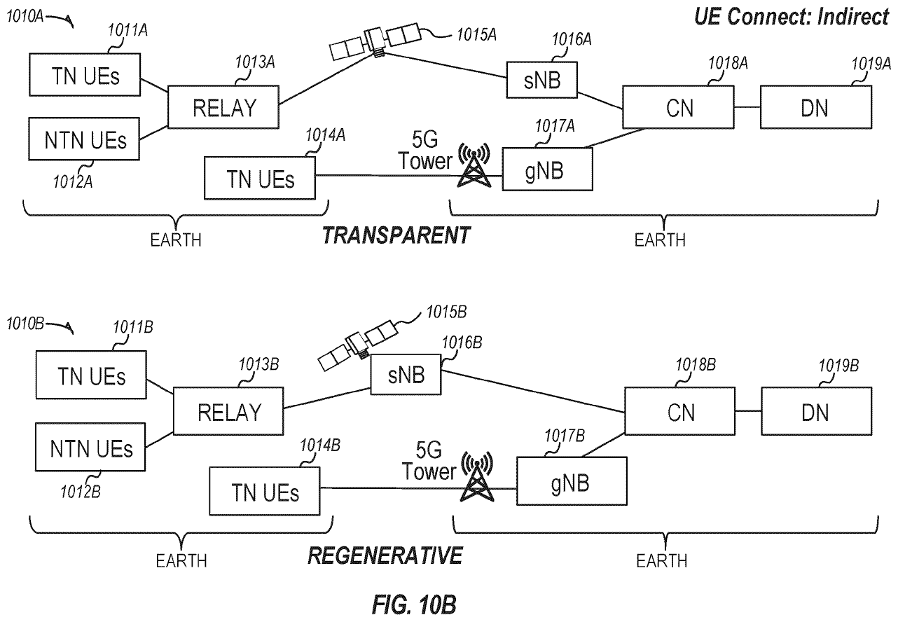

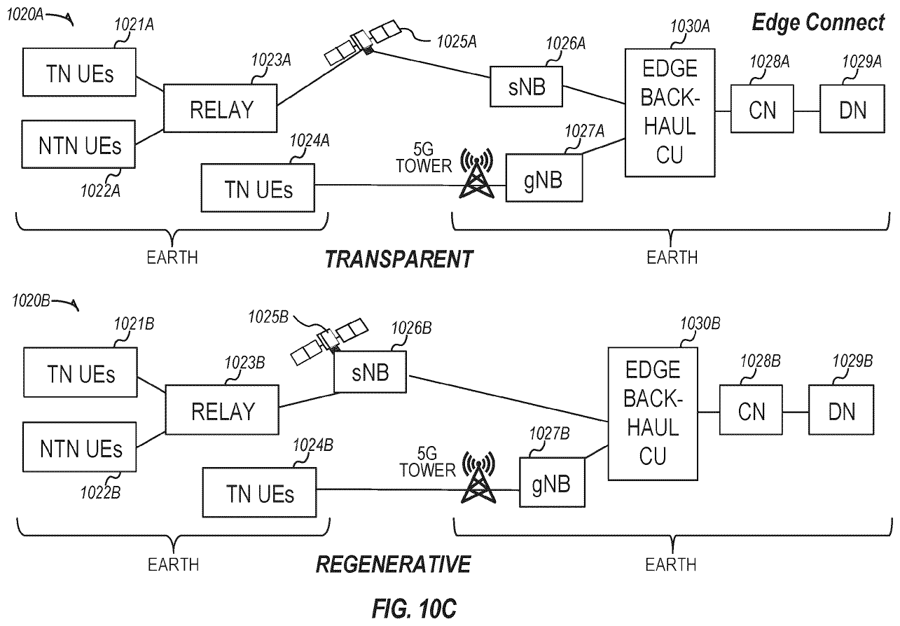

Use of SV ephemeris data and mobility management may be provided for a variety of NTN 5G network settings and architectures. FIG. 10A, FIG. 10B, and FIG. 10C illustrate respective configurations of non-terrestrial and 5G network architectures, as follows:

Direct Connection (with a transparent or “bent pipe” satellite arrangement):
Scenario 1000A in FIG. 10A, e.g., Direct connect: UE 1001A⇔[SATELLITE] 1003B⇔gNB 1002A-CN 1004A⇔DN 1005A;
Scenario 1010A in FIG. 10B, e.g., Multi-RAT, Multi Connectivity provided by transparent NTN-based NG-RAN and Cellular NG-RAN: UEs 1011A or 1012A⇔Relay 1013A⇔[SATELLITE] 1015A⇔gNB 1016A⇔CN 1018A⇔DN 1019A (in this scenario 1010A, TN UEs 1014A can directly connect to a gNB 1017A and the CN 1018A, DN 1019A).
Scenario 1020A in FIG. 10C, e.g., Multi-RAT, Multi Connectivity provided by transparent NTN-based NG-RAN and Cellular NG-RAN: UEs 1021A or 1022A⇔Relay 1023A⇔[SATELLITE] 1025A⇔sNB 1026A⇔Edge back-haul centralized unit (CU) 1030A⇔CN 1028A⇔DN 1029A (in this scenario 1010A, TN UEs 1024A can directly connect to a gNB 1027A and the CN 1028A, DN 1029A via the Edge back-haul CU 1030A).
Direct Connection (with a regenerative satellite with gNB arrangement):
Scenario 1000B in FIG. 10A: UE 1001B⇔sNB 1003A [at SATELLITE 1003B]⇔CN 1004B⇔DN 1005B;
Scenario 1010B in FIG. 10B, e.g., Multi-RAT, Multi Connectivity provided by transparent NTN-based NG-RAN and Cellular NG-RAN: UEs 1011B or 1012B⇔Relay 1013B⇔sNB 1016B [at SATELLITE 1015B]⇔CN 1018B⇔DN 1019B (in this scenario 1010B, TN UEs 1014B can directly connect to a gNB 1017B and the CN 1018B, DN 1019B).
Scenario 1020B in FIG. 10C, e.g., Multi-RAT, Multi Connectivity provided by transparent NTN-based NG-RAN and Cellular NG-RAN: UEs 1021B or 1022B⇔Relay 1023B⇔sNB 1026B [at SATELLITE 1025B]⇔Edge back-haul CU 1030B⇔CN 1028B⇔DN 1029B (in this scenario 1020B, TN UEs 1024B can directly connect to a gNB 1027B and the CN 1028B, DN 1029B via the Edge back-haul CU 1030B).

As will be understood, orbital ephemeris and telemetry ephemeris may be needed for gNB and CN operations, but transparent/regenerative architectures may have different “ephemeris” needs. Such needs may include either orbital and or telemetry data depending on where the data is needed, where the processing of tracking areas is performed, and where the determination of UE coverage is made. Pre-processing of data for network topologies may be planned a few hours to a few days ahead of time depending on the anticipated network traffic, and depending on Earth network node and SV network node health. This planning includes using satellite ephemeris (especially orbital data of expected fly-over data) in addition to the unique state of each SV in the constellation. Using the pre-planned network topology inclusive of SV and GS network nodes, a time-varied network topology is available and can be used to create a time-varied NTN coverage map.

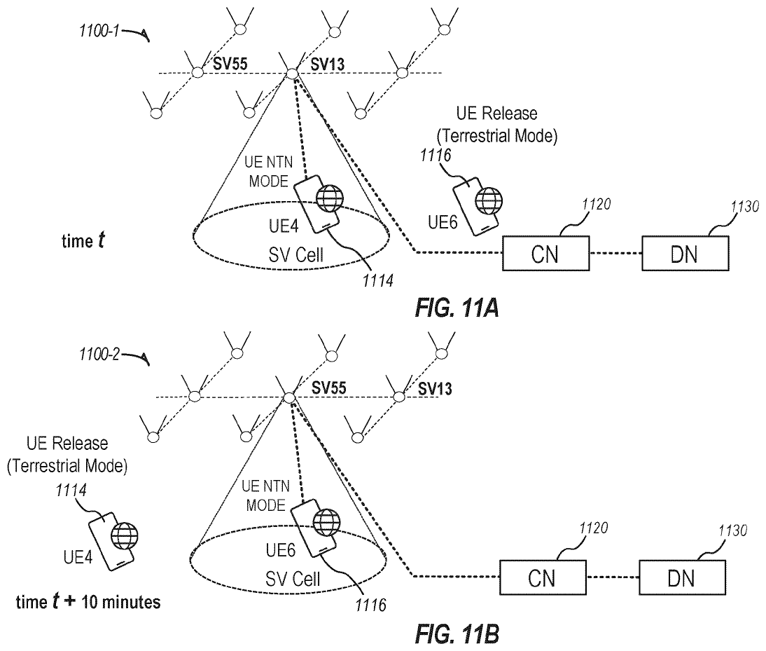

FIG. 11A and FIG. 11B illustrate examples of mobility management based on non-terrestrial network coverage information and verified location. Here, FIG. 11A illustrates a scenario at time t with the positioning of a satellite constellation 1100-1, while FIG. 11B illustrates a scenario at a later time (time t +10 minutes), where the satellite constellation 1100-2 has moved due to orbiting.

As shown in FIG. 11A, at time t, a UE4 1114 is in coverage of an SV cell provided by SV13, and uses the NTN network to connect to a ground station and the 5G core network 1120 and data network 1130. However, UE6 1116 is not in an NTN coverage zone, but is in a UE release and thus is in a terrestrial mode, using network connectivity if available from terrestrial 5G networks. Because no coverage is available, the UE4 should not attempt to connect to an NTN network.

Then, as shown in FIG. 11B, at time t+10 minutes, the orbital position of the constellation 1100-2 has changed to provide coverage from SV55 to UE6 1116 with an SV cell. The UE6 1116 can transition to UE NTN mode to connect to a ground station and the 5G core network 1120 and data network 1130. Because UE4 1114 is no longer in the coverage area, it has transitioned into UE release into a terrestrial mode, using network connectivity if available from terrestrial 5G networks. Because no coverage is available, the UE4 1114 should not attempt to connect to an NTN network.

It will be understood that a precise verified UE Location and Positioning capability is available via the LMF using terrestrial and or non-terrestrial methods (including those discussed above). However, a UE verified location using present 5G network techniques (including with use of soft information) may also be performed, to predict UE location based on previous location and motion, as well as to corroborate UE location using different location methods (e.g., including UL-AoA and UL-TDoA).

For example, consider a Satellite Vehicle that provides the following data:

TABLE 1
NORAD ID: 24793
International ID: 1997-020B
Perigee: 782.5 km (the point at where the SV is closest to Earth)
Apogee: 785.4 km (the point at where the SV is farthest from Earth)
Inclination: 86.4° (angle between the orbital plan and the equatorial
plane. GEO SV inclination is ZERO, POLAR SV orbit is 90 degrees)
Period: 100.4 minutes (amount of time to complete once around earth)
Semi major axis: 7154 km (average distance from SV to center of the
earth)
RCS: 4.1817 m2 (large) (radar cross section, how detectible object is to
radar)

Such data may be provided in TLE format. TLE format is two data lines describing orbital elements for each SV that describes the state including position and velocity of an orbiting SV. For example, consider the following example TLE set for a satellite vehicle:

TABLE 2
1 24793U 97020B 22122.88174365 .00000321 00000-0 10709-3 0 9990
2 24793 86.3913 294.6023 0001995 90.5826 269.5598
14.34478351308215

Additional Details from NORAD for this satellite may include the following data format:

TABLE 3
0 AAAAAAAAAAAAAAAAAAAAAAAA
1 NNNNNU NNNNNAAA NNNNN.NNNNNNNN +.NNNNNNNN
+NNNNN-N +NNNNN-NN NNNNN
2 NNNNN NNN.NNNN NNNNNNN NNN.NNNN NNN.NNNN
NN.NNNNNNNNNNNNNN

In this example, line 0 is a twenty-four character name (to be consistent with the name length in the NORAD satellite catalog (SATCAT)). Lines 1 and 2 are the standard Two-Line Orbital Element Set Format identical to that used by NORAD and NASA. The format description is:

TABLE 4
Line 1

| Column | Description |
|---|---|
| 1 | Line Number of Element Data |
| 3-7 | Satellite Number |
| 8 | Classification (U = Unclassified) |
| 10-11 | International Designator (Last two digits of launch year) |
| 12-14 | International Designator (Launch number of the year) |
| 15-17 | International Designator (Piece of the launch) |
| 19-20 | Epoch Year (Last two digits of year) |
| 21-32 | Epoch (Day of the year and fractional portion of the day) |
| 34-43 | First Time Derivative of the Mean Motion |
| 45-52 | Second Time Derivative of Mean Motion (Leading |
| | decimal point assumed) |
| 54-61 | BSTAR drag term (Leading decimal point assumed) |
| 63 | Ephemeris type |
| 65-68 | Element number |
| 69 | Checksum (Modulo 10) |

(Letters, blanks, periods, plus signs = 0; minus signs = 1)

TABLE 5
Line 2

| Column | Description |
|---|---|
| 1 | Line Number of Element Data |
| 3-7 | Satellite Number |
| 9-16 | Inclination [Degrees] |
| 18-25 | Right Ascension of the Ascending Node [Degrees] |
| 27-33 | Eccentricity (Leading decimal point assumed) |
| 35-42 | Argument of Perigee [Degrees] |
| 44-51 | Mean Anomaly [Degrees] |
| 53-63 | Mean Motion [Revs per day] |
| 64-68 | Revolution number at epoch [Revs] |
| 69 | Checksum (Modulo 10) |

FIG. 12 illustrates a flowchart 1200 of a method of implementing mobility management based on non-terrestrial coverage. Here, this provides an example procedure, which may be modified based on connectivity or network considerations.

In the case of satellite access, before sending a UE Context Release Command message to the RAN, the 5G AMF may initiate the Location Reporting procedure to ask for the last known location of the UE, at operation 1210. The RAN provides all broadcast tracking area identifiers (TAIs) for the selected PLMN to the AMF as part of the ULI, at operation 1220. The RAN also reports the tracking area where the UE is geographically located if this tracking area can be determined, and the RAN may also report the coverage information (e.g., ephemeris data) to the AMF, such as with a Location Reporting procedure, at operation 1230.

Next, the 5G AMF initiates the UE Context Release procedure, at operation 1240. Then, the applicable tracking area for the UE may be determined, at operation 1250. For instance, when the paging is needed and the sub-area based paging (e.g., first page in the last known cell-id or tracking area and retransmission in all registered tracking areas) is determined to apply, the tracking area where the UE is geographically located may be regarded as the last known tracking area. For example, the last known tracking area may be used, if the tracking area where the UE is geographically located is (i) known by the AMF, and (ii) determined in coverage based on the coverage information (e.g., ephemeris data) from the RAN when the paging is needed. The adaptation of the tracking area where the UE is geographically located also may be determined by the AMF implementation.

Implementation of this procedure may provide a variety of impacts on services, entities, and entities of the 5G network and UEs. For example, the 5G AMF may be modified to provide functionality, so that the tracking area where the UE is geographically located may be used to determine the last known tracking area. Further, the coverage information (e.g., ephemeris data) may be used to determine whether a tracking area is in coverage. It will be understood that variation may occur in the definition of satellite ephemeris data (e.g., all or a part of the satellites ephemeris in the RAN), such as what data will be provided to the 5G CN and whether the satellites ephemeris are available in a given RAN node. Likewise, implementation changes in the 5G RAN may include, providing information on the tracking area from the RAN to the AMF where the UE is geographically located (if the tracking area can be determined), and providing the coverage information (e.g., the ephemeris data) from the RAN to the AMF.

It will be understood that the connectivity techniques discussed above may also be used to determine connectivity to particular compute resources and compute locations. For instance, edge computing or edge-cloud/near-cloud computing resources (e.g., low-latency compute resources) located at a particular ground station may be accessible only via particular satellite connections and NTN paths.

Calculation of Location with Time Difference of Arrival (TDoA) using Non-Terrestrial Networks

As will be understood, a variety of approaches may be used for positioning UEs within a 5G/NR network provided by an NTN (e.g., LEO constellation). One positioning approach is a Multi-RTT (Multi-Round Trip Time, or mRTT) approach, where the UE reports Rx-Tx time differences. Another positioning approach is the use of a DL-TDoA (Downlink Time Difference of Arrival) approach, where the UE reports a RSTD (reference signal time difference). Yet another approach is an UL-TDoA approach, where the UE transmits an SRS (sounding reference signal).

The following introduces adaptations to enable an improved implementation of an UL TDoA approach in an NTN 5G/NR network. The following techniques for NTN UL TDoA may be implemented using off-the-shelf UEs (e.g., standard 3GPP compliant smartphones), using an SRS signal transmit from a UE or ground station during the SV contact window. A payload on the SV calculates the timing advance provided to the UE (in the same fashion as performed by a terrestrial network). This enables the UL-TDoA to be calculated with either earth-fixed, constellation coordinate, and/or inertia systems. These and similar approaches address real world issues of (1) reducing latency, (2) improving accuracy, (3) and addressing verification of location results.

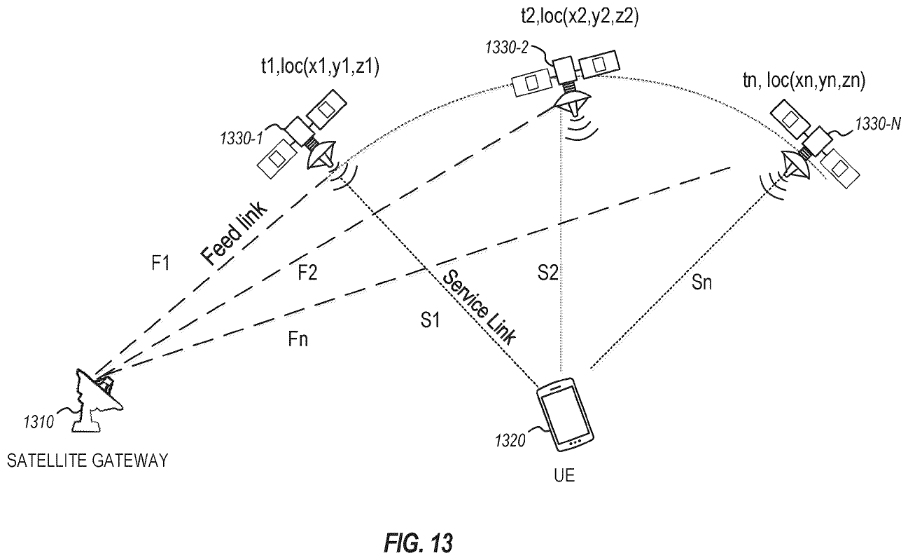

FIG. 13 illustrates a scenario for determining TDoA from a non-terrestrial network. Here, a satellite gateway 1310 offers respective feeds F1, F2, Fn to satellites 1330-1, 1330-2, 1330-N. A UE 1320 establishes service links with the satellites 1330-1, 1330-2, 1330-N, using service links S1, S2, Sn. In this setting, an UL-TDoA position estimation of the UE may be performed based on the time difference of signals received from the UE 1320 at satellites 1330-1, 1330-2, 1330-N, based on the known positions of the satellites 1330-1, 1330-2, 1330-N.

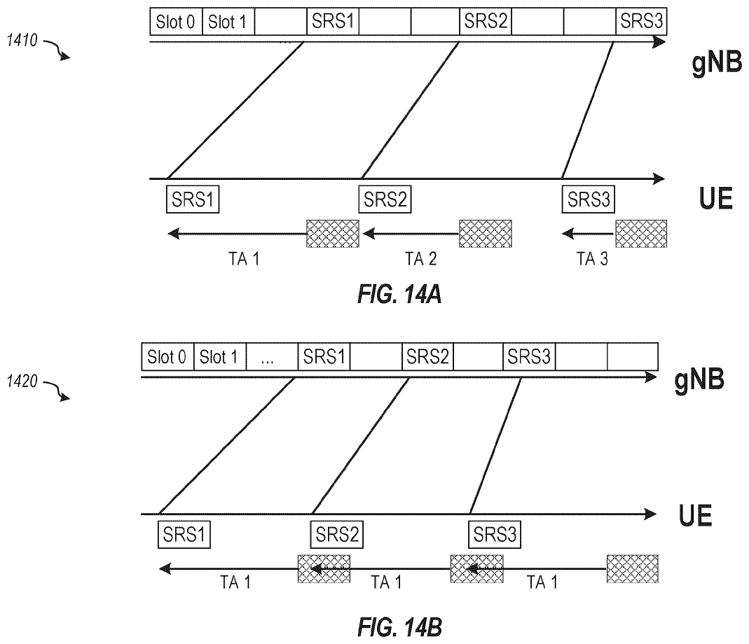

One important technical concern to implement UL-TDoA is a timing advance (TA) problem, specifically, how to accurately obtain TA calculations in an NTN setting, in a similar fashion to how a TN gNB provides TA calculations to enable a UE to align SRS transmissions into slots (e.g., shown in FIGS. 14A and 14B, discussed below). One of the problems with TA calculations occurs in a NTN setting occurs because the actual time difference measurements are ambiguous at the gNB, due to autonomous adjustment of TAs at the UE based on GNSS measurements. Additionally, concerns have been raised regarding the UL link budget (e.g., the accuracy of resulting measurements) and UE power consumption (e.g., to perform SRS transmissions).

FIG. 14A and FIG. 14B illustrates two scenarios 1410, 1420 of determining a timing advance between a UE and a gNB network. A first approach for addressing for TA issues in NTN settings includes TA reporting for each SRS transmission. In this setting, an SRS may not be needed, considering that the distance can be calculated based on TA by itself. This is depicted in scenario 1410, where the TA is updated by the UE in accordance with the delay. However, it will be understood that the timing difference is meaningless if the TA update is not reported by the UE.

A second approach for addressing TA issues in NTN settings includes using a fixed TA for measurements. This is depicted in the scenario 1420, where the TA is fixed. However, there may be significant uncertainty for SRS reception timing at the gNB (e.g., the time of SRS reception at the gNB is often ambiguous).

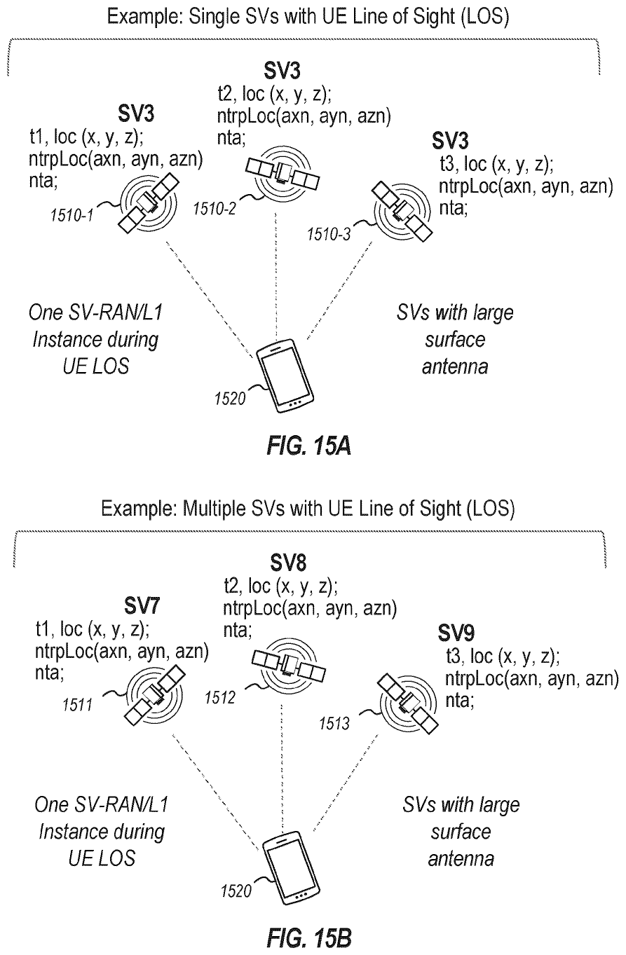

FIGS. 15A and 15B illustrate respective approaches for determining an uplink TDoA, between a UE and NTN gNBs. In these examples, the following data is provided between the entities to calculate UL TDoA:

TABLE 6

| | |
|---|---|
| (orbital data) | SV loc (x1, y1, z1), timestamp (t1) |
| (data) | SV_ANT antennaLoc (ax1, ay1, ax1) for each antenna n |
| (measurement) | SV-L1 calculates RTOA for each UE-SV_ANT pair |
| | during LOS |
| (measurement) | SV-L1 calculates TA for each UL SRS for each UE- |
| | SV_ANT pair during LOS |
| (inform) | SV-LI provides UE TA to apply to next SRS during |
| | LOS |

In the example of FIG. 15A, a single SV (SV3, 1510) with LOS to a UE 1520 includes a large surface antenna, and the single SV (SV3) operates at times t1, t2, and t3 (labeled as 1510-1, 1510-2, 1510-2) to perform the measurements as noted in TABLE 6. In this setting, the single SV is connected to one SV-RAN-L1 instance during the LOS to the UE 1520.

In the example of FIG. 15B, multiple SVs (SV7 1511, SV8 1512, SV9 1513) also have LOS to the UE 1520. Each of the SVs (SV7 1511, SV8 1512, SV9 1513) includes a large surface antenna and provides signals to the UE 1520 at times t1, t2, t3, respectively.

With either example, once the SRS signal is received from the UE 1520 at the transmission reference point (e.g., the respective Satellite Antenna), the difference in arrival time at different Satellite Antennas (of the same SV) can be used to calculate distance from the UE to the respective SV. The TDoA/Reverse TDoA (RTDoA) then may be calculated from this information.

For transparent NTN locations, the Earth-based LMF coordinates with the Earth-based virtual RAN Edge server can use a New NR positioning protocol A (NRPPa) protocol to enable the Earth-based UE to transmit SRS signals to a single SV at different times within the line-of-sight window. This line-of-sight window often varies based on the orbit of constellation but is typically between 3-10 minutes. Accordingly, SRS signals transmitted by the UE to the SV can enable a number of measurements to be made by the virtual RAN such as RSRQ, RSRP, round trip signal propagation time (RTT), AoA, or ToA. Such measurements may occur several times during the SV line of sight, depending on the measurement periodicity and latency requirements. Adaptation also may occur depending on the use case or context. For example, an emergency service may allow fewer measurements for faster response whereas other requests may use more measurements (and take longer) to improve accuracy.

### Orbit Verified and Corroborated UE Positioning

In further examples, the techniques discussed above may be extended to enable the use of UE positioning or UE location information that is verified (e.g., validated, or corroborated) based on orbit data. Specifically, the following refers to an Orbit-Verified (OV) approach that uses orbital data satellite position or expected position (including inclination, epoch) to verify the UE positioning. The following orbit-verified approaches may be used with a variety of non-terrestrial systems, whether earth-fixed or constellation coordinate systems and/or inertia systems. Alternatively or in addition, the following orbit-verified approaches may be used to direct UE Time of Flight (ToF)/Time of Arrival (ToA) measurements toward a ground station.

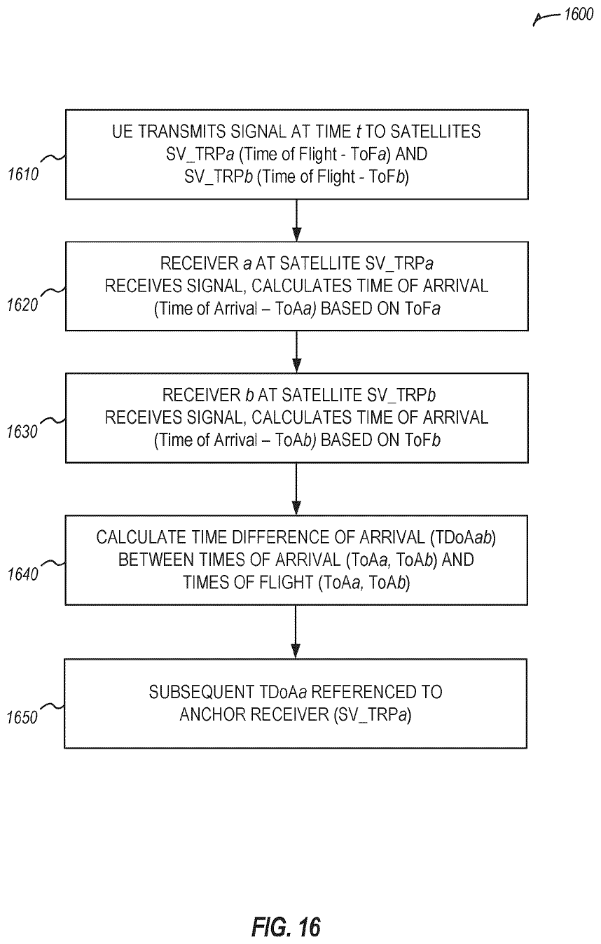

FIG. 16 illustrates a flowchart 1600 of a method for calculating a UE UL-TDoA with a non-terrestrial network including one or more transmission and reception points (TRPs) at respective SVs (consistent with the UL-TDoA examples discussed above). As depicted in flowchart 1600, the following sequence occurs:
At 1610: UE transmits a signal at time t, where Time of Flight (ToF)=d (distance)/c (velocity) to SV_TRPa=ToFa, and to SV_TRPb=ToFb.
At 1620: SV_TRPa receiver a has a distance to UE da with Time of Arrival (ToA) from UE a to SV_TRPa, such that ToAa=t+ToFa=t+da/c.
At 1630: SV_TRPb receiver b has a distance to UE db with Time of Arrival (ToA) from UE a to SV_TRPb, such that ToAb=t+ToFb=t+db/c.
At 1640: For SV_TRPa and SV_TRPb receivers, the Time Difference of Arrival (TDoAab)=ToAb−ToAa=ToFb−TOFa=(db-da)/c.
At 1650: All subsequent TDoAs are referenced to same anchor receiver SV_TPRa. A time sync between SV_TRPs and UEs are not required; but a time sync between SV_TRPs and or SVs is required. It will be understood that four ToAs can be used for triangulating a three-dimensional position of the UE.

Accordingly, the use of NTN network-verified location with orbit-verification provides a configuration such that LEO orbit data can “replace” GPS for verification, without the possibility of GNSS-spoofing. Thus, LEO orbital data of a contact SV can be used to verify a position of UE and/or a ground station.

As will be understood, NTN UL-TDoA without OV may encounter a number of limitations. These include, being subject to GNSS-spoofing attacks; UE complexity to calculate TA; UE battery drain; and the reliance on the GNSS system for network “verification”. In contrast, NTN NV LOC with OV uses expected LEO satellite SV orbital direction and position to “verify” (validate, corroborate) a UE location, and does not rely on the UE limitations. Moreover, an NTN network-verified location using orbit-verified data can be calculated from a UE to an SV, or from a Ground Station (GS) to an SV. The SV position and velocity is known for constellations, and is fixed to stars and not earth rotation. SV position and velocity can be described in readily available two-line-elements at epoch.

In further examples, a transmitter can be used as a Ground Station with fixed earth in relation to constellation movements. Also, in some further examples, “fixed” positions can be calculated using earth-fixed coordinate system for ToF “d” distances.

The orbit-verification techniques above may be used to verify the resulting location calculation x.y.z (with the use of calculations in transparent or regenerative network connections, e.g., at an on-ground edge server or in-orbit edge server) with impossible to spoof orbital data for the specific constellation. This data is impossible to spoof because all orbital data epoch is available ahead of time in TLE (two-line element) format.

Accordingly, in a network deployment, A-GNSS network locations (that can be spoofed) can be replaced with an orbital-verified method to satisfy the NTN NR UE location-verified requirement. Further, the use of an in-orbit architecture and calculation can reduce latency further, allowing UE location to be more quickly determined especially for emergency response settings.

In further examples, an NTN NR location measurement can be scheduled or “pre-fetched” ahead of time. A constellation may use orbital intelligence to schedule “location” contacts and measurements from multiple SVs, ahead of time, to reserve network capacity and fast-path UL signaling to reduce measurement latency.

Likewise, in further examples, an NTN NR location measurement can be coordinated with the use of a tracking area, including those areas associated with an “exclusion area”, “inclusion area”, or “coordination area” or similar area footprints from a LEO SV or LEO constellation. Further information on such exclusion zones can be found in International Patent Application No. PCT/US2021/024456, titled SATELLITE 5G TERRESTRIAL AND NON-TERRESTRIAL NETWORK INTERFERENCE EXCLUSION ZONES, which is incorporated by reference herein.

Calculation of UE Location with Multi-Round Trip Time (mRTT) Techniques Using Non-Terrestrial Networks

In a further example, mRTT measurement techniques may be used for calculation and verification of UE locations, including in combination with the examples above. A 5G network that includes AMF and LMF components can obtain an SV position vector to then calculate the SV TRPs. These TRPs then can be used to perform mRTT measurement operations, to determine and verify the geolocation of a particular UE.

In an example configuration, at least three Rx/Tx TRPs at the same or different SVs (e.g., the single SV used in the configuration shown in FIG. 15A, or the multiple SVs used in the configuration shown in FIG. 15B) may be used for determining a geolocation of a UE. The SV position vectors can be obtained directly by the AMF-LMF from a space data source (e.g., NORAD, or Spacetracker), instead of the NTN-UE obtaining the data and providing the data values to the serving AMF-LMF, thereby reducing unnecessary link usage and maintaining link budgets. SV Position Vectors and associated ephemeral data such as, transmitter and receiver characteristics of satellites and ground stations—as well as atmospheric conditions for links—can be obtained by certified or trusted space data sources. With this information, the AMF-LMF can then use the SV position vectors to independently verify the UE-network location.

The following mRTT non-terrestrial location calculation techniques address a number of technical considerations with in-motion TRPs. Terrestrial mRTT techniques that determine locations in TNs involve the consideration of fixed TRPs (on Earth), because the location of the gNB/TRP is fixed. In contrast, mRTT techniques used with LEO NTNs need to consider that SVs provide in-motion TRPs, and so the SV TRP location is changing. The following techniques therefore use a third-party data source to enable a serving gNB to obtain and provide coordinates for the overhead signal. Obtaining the SV position vectors directly from a third-party data source (e.g., NORAD/Spacetracker) reduces dependency on a UE to find and send data values to the AMF-LMF. The use of a third-party data source also reduces the potential for spoofing interference among the UE-gNB-LMF, and also results in less over-the-air traffic.

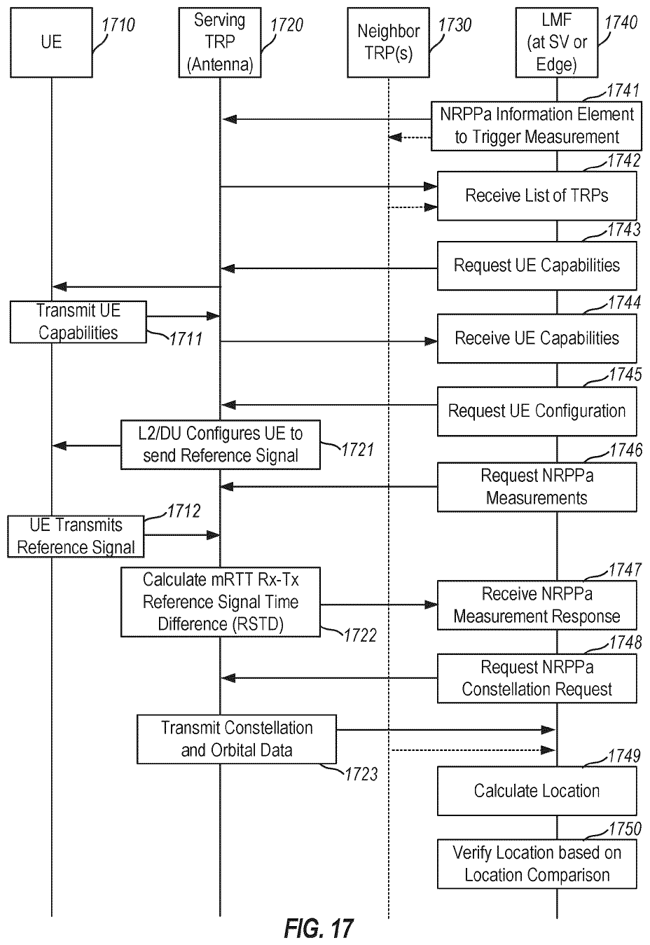

In a 3GPP NTN, an SV is constantly monitoring and searching for Physical Random Access Channel (PRACH) signals from NTN capable UEs. In the 3GPP NTN, PRACH signals are not scheduled; rather, an NTN UE can attach to a serving cell, authenticated via the 5G Core/AMF/Authentication Server Function (AUSF). Then, when the NTN Serving Core/AMF/LMF receives a request to find location of a particular UE (e.g., UE #12345), the Serving SV gNB for UE #12345 conducts the following mRTT location calculation operations (e.g., also shown in operations 1712, 1721, 1722, 1723 in FIG. 17, discussed below):
(a) The Serving SV gNB for the UE (e.g., UE #12345) schedules the SV-to-NTN-UE reference signal such as a Positioning Reference Signal (PRS) down from a single line-of-sight SV to the UE. This may be provided as a broadcast among multiple areas, as the multicast name suggests.
(b) The same NTN UE (e.g., UE #12345) sends a reference signal such as Sounding Reference Signal (SRS) to the line-of-sight SV. Thus, to perform the mRTT technique, the PRS and the SRS are scheduled between the connected SV and UE; the PRS and the SRS or similar signals may be provided according to standardized (e.g., 3GPP-defined) reference signals. Reference Signal Transmission may need timing advance (TA) adjustments to account for the signal propagation between UE and satellite. For standard 3GPP Terrestrial communications, the uplink SRS timing is based on downlink received timing and propagation delay. NTN propagation delay is greater than that of terrestrial communications, and may exceed 3GPP transmission slots (e.g., which vary). To account for the NTN propagation delay, SV position vector ephemeris can be used to calculate the round trip time of (RTT) of reference signals between the UE and satellite once the location of the UE is known.

The initial location of the UE can be provided by a GNSS source for initial calculations, and then verified using the mRTT techniques disclosed herein. As an example, the initial UE location may be obtained by using a UE with GNSS capabilities, and then subsequent UE position calculations can be performed without relying on further UE GNSS measurements. Using the initial UE position via GNSS—as well as the SV position vector ephemeral data—the AMF-LMF can calculate the relative speed between the UE and SV as well as the relative RTT of reference signals between the UE and the particular SV TRPs. Additionally, the UE can then add the RTT between the UE and the SV to the standard Timing Advance (TA) provided by the gNB to ensure that the UE to SV offset is applied to reference signal transmission. This UE to SV offset enables the UE to send uplink/downlink reference signal transmissions in both NR Random Access RACH and connected modes to the gNB to aligned signal transmissions and enables the UE to use standard 3GPP transmission slots.
(c) At least three TX-RX measurements occur between the same UE and the same SV. The time difference between the UE and SV reference signals are then calculated and transmitted to the LMF.
(d) The LMF obtains the orbit information or the SV of that constellation from a verified certified source (e.g., NORAD or Spacetracker). The LMF then can calculate the UE geographic position (e.g., an x,y,z position), and provide the position x.y,z in a response tracking and further processing.

FIG. 17 depicts a flow diagram of operations for a multicast round trip time (mRTT) location calculation. This flow diagram specifically depicts operations between a UE 1710, a serving TRP 1720 (e.g., an antenna at a first SV), one or more neighbor TRPs 1730 (if available, e.g., at respective antennas of other SVs), and a LMF 1740 (located at the SV or at an on-earth edge processing location). Other entities may be involved consistent with the examples herein.

The flow diagram begins at 1741, with the use of an LMF command or data element (e.g., the NR Positioning Protocol A (NRPPa) information element as defined by a 3GPP 5G Location Information Transfer Procedure) to trigger a location measurement via a TRP. The LMF then, at 1742, can receive a listing of TRPs from the serving TRP 1720, and any neighbor TRPs 1730.

Next, the LMF 1740 requests that the serving TRP 1720 obtain the UE capabilities. The serving TRP 1720 may obtain data relating to these capabilities as the UE 1710 transmits its UE capabilities at 1711, and then the serving TRP 1720 provides the UE capabilities at 1744 to the LMF 1740.

The LMF 1740 may configure the use of the mRTT procedure by requesting a UE configuration at 1745 to the serving TRP 1720. The serving TRP 1720 then configures the UE at 1721 (e.g., with use of a L2/Du), to cause the UE to send a reference signal and to coordinate the schedules to transmit/receive this reference signal (e.g., with PRS and SRS signals, as discussed above).

The LMF 1740 provides a NRPPa measurement request at 1746, and the UE transmits a reference signal at 1712. Based on this reference signal, the serving TRP 1720 can calculate the mRTT Rx-Tx reference signal time difference (RSTD) at 1722, which is then used to provide the NRPa measurement response at 1747 to the LMF 1740.

These measurement operations may be followed by verification operations at the LMF 1740, to validate that the provided data is valid based on the expected position of the SV (e.g., for a specific location and provider). This is shown at 1748 with a request of NRPP constellation information. The serving TRP 1720 (and optionally, the neighbor TRPs) respond at 1723 with constellation and orbital data. Accordingly, the LMF 1740 can use the preceding information to calculate the location of the UE at 1749, and to verify the location based on a location comparison at 1750.

In an example, the serving AMF is responsible to trigger the verification procedure. This may be used in a setting where the RAN2 assumes that the network is able to compute possible UE locations, independently from the GNSS location reported by the UE. This also may be used in a setting where the RAN2 assumes that the UE location verification procedure can be triggered by the CN (and, it is up to the CN to decide when to trigger the procedure). The RAN2 can allow the verification of the consistency (e.g., within 5-10 km) between the actual reported UE location with the UE location(s) to be computed by the network, based on applicable features of the 5G core.

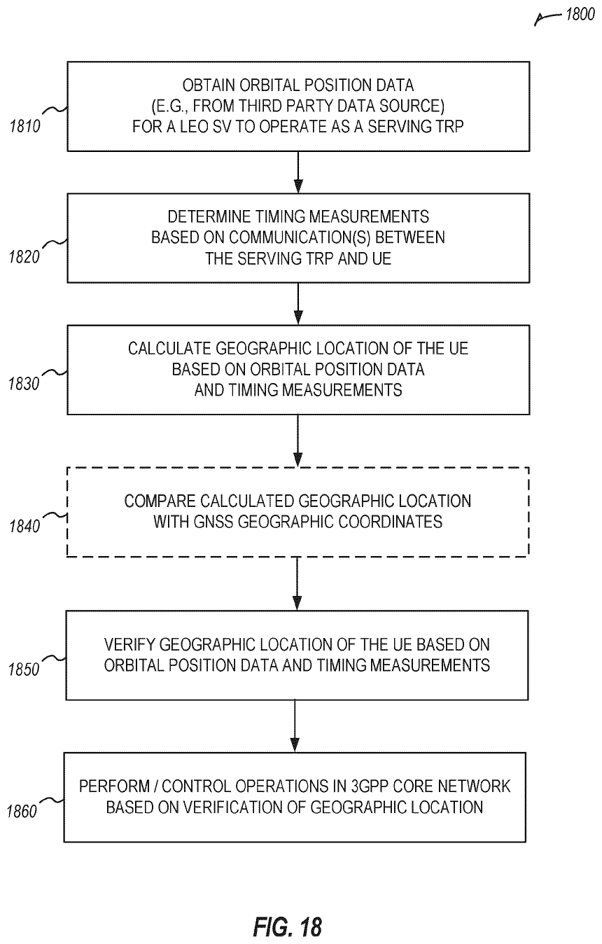

FIG. 18 illustrates a flowchart 1800 of a method of non-terrestrial-network (NTN)-assisted location calculation and verification for a terrestrial user equipment (UE). This flowchart 1800 specifically refers to location techniques discussed with reference to aspects of FIG. 15A, FIG. 17, and mRTT operations, but it will be understood that additional operations may be performed or substituted. Additionally, these method operations are depicted from the perspective of an on-ground system that performs processing (e.g., a computing system that operates as a Location Management Function (LMF) or Access and Mobility Management Function (AMF) of a 3GPP network), but it will be understood that counterpart perspectives and operations may occur at an in-orbit data center or other network element.

The flowchart 1800 begins at 1810 to obtain orbital position data (e.g., from a third party data source), to identify a LEO SV that can operate as a serving transmission and reception point (TRP) to a user equipment (UE). In an example, the orbital position data is obtained from a third-party data source of satellite positioning data (e.g., NORAD or Spacetracker).

The flowchart 1800 continues at 1820 to determine a timing measurement based on at least one communication between the serving TRP and UE. In an example, the at least one communication provides a reference signal (e.g., PRS or SRS signal), and the timing measurement is a reference signal time difference between a receipt and a transmission of the reference signal between the SV and the UE. Specifically, the reference signal may be scheduled between an SV and a UE according to the mRTT positioning methods discussed above.

The flowchart 1800 continues at 1830 to calculate geographic location of the UE based on the orbital position data and the timing measurements. This may be performed using the reference signals and mRTT positioning methods discussed above.

The flowchart 1800 continues at 1840 with an optional operation to compare the calculated geographic location with GNSS geographic coordinates (e.g., GPS coordinates) that are known for the UE (e.g., provided by the UE). In an example, this operation may include obtaining UE geographic position data based on coordinates obtained from the GNSS (e.g., GPS). As explained above, the coordinates may provide an initial position to calculate a timing advance for the UE (e.g., for a reference signal offset of the at least one communication), and verification also may be performed based on these coordinates.

The flowchart 1800 continues at 1850 to verify the geographic location of the UE based on orbital position data and the timing measurements (and optionally, the GNSS geographic coordinates). For example, an expected position of the UE based on the SV coverage (determined from the orbital position data) may be compared to the measured position of the UE based on the timing measurements. In a further example, verification may include further verifying the geographic location of the UE based on the UE-provided geographic position data. For instance, this may include a match or comparison of the UE geographical position data obtained from the GNSS and provided by the UE with the calculated geographic location, e.g., to verify the UE position with information from a trusted or certified space data source of ephemeral data.

The flowchart 1800 concludes at 1860 to perform or control operations in 3GPP Core Network (CN) based on the verification (or, lack of verification) of the geographic location for the UE. In an example, the operations to calculate the geographic location of the UE and to verify the geographic location are triggered or controlled by operations in the 3GPP CN. For instance, the 3GPP

CN or another entity may determine an expected geographic UE based on the orbital position data, and then control an operation in the 3GPP network based on a comparison of the geographic location of the UE with the expected geographic location of the UE (e.g., requiring a match or a sufficient similarity to the expected location).

In a further example, additional orbital position data may be obtained for at least two other low-earth orbit SVs that operate as neighbor TRPs to the serving TRP. Then, additional timing measurements may be performed via at least one communication (e.g., reference signals) between each of the neighbor TRPs and the UE. In this scenario, the geographic location of the UE is further calculated based on the additional orbital position data and the additional timing measurements.

### Further Satellite Location Processing Examples

The preceding techniques may be applied in a non-terrestrial network that uses a (1) “bent pipe” network connection, also referred to above as a “transparent” network processing (e.g., to an edge server on earth with a virtual RAN doing the measurements for the various location methods), or (2) a “regenerative” network, also referred to above as “in-orbit” network processing, where processing is performed at the satellite, potentially cutting latency in half.

Although the description above is focused on 5G signals, it will be understood that these measurements and location-determination techniques can be extended to include other sensors and radio networks. Other methods for network-positioning (UL-TDoA, multi-cell RTT) and UE-positioning (DL-TDoA, DL-AoA) may be used or modified in combination with the present techniques. Thus, NTN network-based approaches may involve (or require) any number of additional transmission and measurements, and coordination operations.

In the examples above, many references were provided to low-Earth orbit (LEO) satellites and constellations. However, it will be understood that the examples above are also relevant to many forms of in-orbit satellites and constellations, stationary (geosynchronous) orbit satellites and constellations, and other high altitude communication platforms such as balloons, drones, airships and blimps, etc. Thus, it will be understood that the techniques discussed for LEO networks are also applicable to many other network settings.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.
Example 1 is a computing system, comprising: processing circuitry; and a memory device including instructions embodied thereon, wherein the instructions, which when executed by the processing circuitry, configure the processing circuitry to perform operations that: obtain orbital position data for a low-earth orbit satellite vehicle (SV), the low-earth orbit SV to operate as a serving transmission and reception point (TRP) to a user equipment (UE); determine a timing measurement of at least one communication between the serving TRP and the UE; and calculate a geographic location of the UE based on the orbital position data and the timing measurement.
In Example 2, the subject matter of Example 1 optionally includes subject matter where the instructions further configure the processing circuitry to perform operations that: determine an expected timing measurement of the at least one communication between the TRP and the UE, based on the orbital position data; and verify the geographic location of the UE based on a comparison of the timing measurement with the expected timing measurement.
In Example 3, the subject matter of Example 2 optionally includes subject matter where the instructions further configure the processing circuitry to perform operations that: obtain UE geographic position data, based on coordinates obtained at the UE from a global navigation satellite system (GNSS), wherein the coordinates provide an initial position to calculate a timing advance for the UE (e.g., for a reference signal offset of the at least one communication), and wherein the geographic location of the UE is further verified based on the a comparison of the UE geographic position data with the calculated geographic location.
In Example 4, the subject matter of any one or more of Examples 1-3 optionally include subject matter where the instructions further configure the processing circuitry to perform operations that: perform an operation in a core network (CN) of a 3GPP network, based on verification of the geographic location of the UE; wherein operations to calculate the geographic location of the UE and to verify the geographic location are triggered by the CN.
In Example 5, the subject matter of any one or more of Examples 1˜4 optionally include subject matter where the at least one communication provides a reference signal, and wherein the timing measurement is a reference signal time difference between a receipt and a transmission of the reference signal from the UE.
In Example 6, the subject matter of Example 5 optionally includes subject matter where the reference signal is scheduled according to a Multi-Round Trip Time (mRTT) positioning method.
In Example 7, the subject matter of any one or more of Examples 1-6 optionally include subject matter where the orbital position data is obtained from a third-party data source of satellite positioning data.
In Example 8, the subject matter of any one or more of Examples 1-7 optionally include subject matter where the instructions further configure the processing circuitry to perform operations that: obtain additional orbital position data for at least two other low-earth orbit SVs to operate as neighbor TRPs to the serving TRP; and determine additional timing measurements of at least one communication between each of the neighbor TRPs and the UE; wherein the geographic location of the UE is further calculated based on the additional orbital position data and the additional timing measurements.
In Example 9, the subject matter of any one or more of Examples 1-8 optionally include GPP network.
In Example 10, the subject matter of Example 9 optionally includes subject matter where the instructions further configure the processing circuitry to perform operations that: determine an expected geographic location of the UE based on the orbital position data; and control an operation in the 3GPP network based on a comparison of the geographic location of the UE with the expected geographic location of the UE.
Example 11 is a method for non-terrestrial network (NTN)-assisted location calculation for a terrestrial user equipment (UE), performed by processing circuitry of a computing system, the method comprising: receiving orbital position data for a low-earth orbit satellite vehicle (SV), the low-earth orbit SV to operate as a serving transmission and reception point (TRP) to a user equipment (UE); determining a timing measurement of at least one communication between the serving TRP and the UE; and calculating a geographic location of the UE based on the orbital position data and the timing measurement.
In Example 12, the subject matter of Example 11 optionally includes determining an expected timing measurement of the at least one communication between the TRP and the UE, based on the orbital position data; and verifying the geographic location of the UE based on a comparison of the timing measurement with the expected timing measurement.
In Example 13, the subject matter of Example 12 optionally includes obtaining UE geographic position data, based on coordinates obtained at the UE from a global navigation satellite system (GNSS), wherein the coordinates provide an initial position to calculate a timing advance for the UE (e.g., for a reference signal offset of the at least one communication), and wherein the geographic location of the UE is further verified based on the a comparison of the UE geographic position data with the calculated geographic location.
In Example 14, the subject matter of any one or more of Examples 11-13 optionally include performing an operation in a core network (CN) of a 3GPP network, based on verification of the geographic location of the UE; wherein operations to calculate the geographic location of the UE and to verify the geographic location are triggered by the CN.
In Example 15, the subject matter of any one or more of Examples 11-14 optionally include subject matter where the at least one communication provides a reference signal, and wherein the timing measurement is a reference signal time difference between a receipt and a transmission of the reference signal from the UE.
In Example 16, the subject matter of Example 15 optionally includes subject matter where the reference signal is scheduled according to a Multi-Round Trip Time (mRTT) positioning method.
In Example 17, the subject matter of any one or more of Examples 11-16 optionally include subject matter where the orbital position data is obtained from a third-party data source of satellite positioning data.
In Example 18, the subject matter of any one or more of Examples 11-17 optionally include obtaining additional orbital position data for at least two other low-earth orbit SVs to operate as neighbor TRPs to the serving TRP; and determining additional timing measurements of at least one communication between each of the neighbor TRPs and the UE; wherein the geographic location of the UE is further calculated based on the additional orbital position data and the additional timing measurements.
In Example 19, the subject matter of any one or more of Examples 11-18 optionally include GPP network.
In Example 20, the subject matter of Example 19 optionally includes determining an expected geographic location of the UE based on the orbital position data; and controlling an operation in the 3GPP network based on a comparison of the geographic location of the UE with the expected geographic location of the UE.
Example 21 is at least one non-transitory machine-readable medium capable of storing instructions for non-terrestrial network (NTN)-assisted location calculation of a terrestrial user equipment (UE), wherein the instructions when executed by at least one processor cause the at least one processor to perform operations comprising: receiving orbital position data for a low-earth orbit satellite vehicle (SV), the low-earth orbit SV to operate as a serving transmission and reception point (TRP) to a user equipment (UE); determining a timing measurement of at least one communication between the serving TRP and the UE; and calculating a geographic location of the UE based on the orbital position data and the timing measurement.
In Example 22, the subject matter of Example 21 optionally includes the operations further comprising: determining an expected timing measurement of the at least one communication between the TRP and the UE, based on the orbital position data; and verifying the geographic location of the UE based on a comparison of the timing measurement with the expected timing measurement.
In Example 23, the subject matter of Example 22 optionally includes the operations further comprising: obtaining UE geographic position data, based on coordinates obtained at the UE from a global navigation satellite system (GNSS), wherein the coordinates provide an initial position to calculate a timing advance for the UE (e.g., for a reference signal offset of the at least one communication), and wherein the geographic location of the UE is further verified based on the a comparison of the UE geographic position data with the calculated geographic location.
In Example 24, the subject matter of any one or more of Examples 21-23 optionally include the operations further comprising: performing an operation in a core network (CN) of a 3GPP network, based on verification of the geographic location of the UE; wherein operations to calculate the geographic location of the UE and to verify the geographic location are triggered by the CN.
In Example 25, the subject matter of any one or more of Examples 21-24 optionally include subject matter where the at least one communication provides a reference signal, and wherein the timing measurement is a reference signal time difference between a receipt and a transmission of the reference signal from the UE.
In Example 26, the subject matter of Example 25 optionally includes subject matter where the reference signal is scheduled according to a Multi-Round Trip Time (mRTT) positioning method.
In Example 27, the subject matter of any one or more of Examples 21-26 optionally include subject matter where the orbital position data is obtained from a third-party data source of satellite positioning data.
In Example 28, the subject matter of any one or more of Examples 21-27 optionally include the operations further comprising: obtaining additional orbital position data for at least two other low-earth orbit SVs to operate as neighbor TRPs to the serving TRP; and determining additional timing measurements of at least one communication between each of the neighbor TRPs and the UE; wherein the geographic location of the UE is further calculated based on the additional orbital position data and the additional timing measurements.
In Example 29, the subject matter of any one or more of Examples 21-28 optionally include GPP network.
In Example 30, the subject matter of Example 29 optionally includes the operations further comprising: determining an expected geographic location of the UE based on the orbital position data; and controlling an operation in the 3GPP network based on a comparison of the geographic location of the UE with the expected geographic location of the UE.
Example 31 is an apparatus, comprising respective means for implementing, deploying, or using a non-terrestrial network/user equipment location technique, in accordance with Examples 1-30, or the other techniques discussed herein.
Example 32 is a satellite vehicle comprising circuitry for implementing, deploying, or using a non-terrestrial network/user equipment location technique, in accordance with Examples 1-30, or the other techniques discussed herein.
Example 33 is a satellite constellation comprising respective satellite vehicles for implementing, deploying, or using a non-terrestrial network/user equipment location technique, in accordance with Examples 1-30, or the other techniques discussed herein.
Example 34 is an edge computing system, comprising terrestrial processing equipment configured for implementing, deploying, or using a non-terrestrial network/user equipment location technique, in accordance with Examples 1-30, or the other techniques discussed herein.
Example 35 is a network comprising respective devices and device communication mediums for performing any of the operations or techniques in Examples 1-30, or discussed herein.
Example 36 is a system comprising respective components arranged or configured to perform any of the operations or techniques in Examples 1-30, or discussed herein.
Example 37 is a method, performed using specially configured circuitry of a device, arranged or configured to perform any of the operations or techniques in Examples 1-30, or discussed herein.

### Implementation in Edge Computing Scenarios

It will be understood that the present satellite communication and networking arrangements may be integrated with many aspects of edge computing strategies and deployments. Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

In the context of satellite communication networks, edge computing operations may occur, as discussed above, by: moving workloads onto compute equipment at satellite vehicles; using satellite connections to offer backup or (redundant) links and connections to lower-latency services; coordinating workload processing operations at terrestrial access points or base stations; providing data and content via satellite networks; and the like. Thus, many of the same edge computing scenarios that are described below for mobile networks and mobile client devices are equally applicable when using a non-terrestrial network.

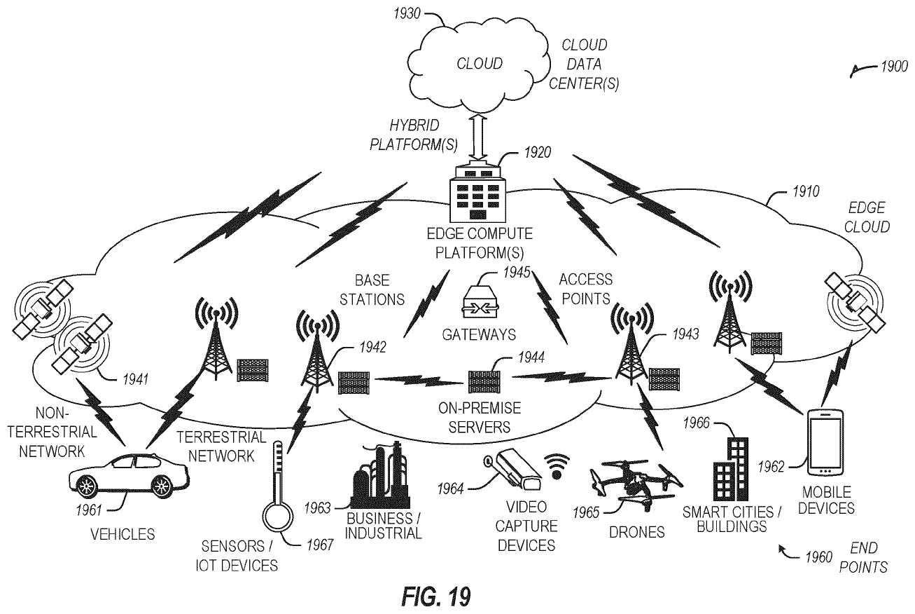

FIG. 19 is a block diagram 1900 showing an overview of a configuration for edge computing, which includes a layer of processing referenced in many of the current examples as an “edge cloud”. This network topology, which may include a number of conventional networking layers (including those not shown herein), may be extended through use of the satellite and non-terrestrial network communication arrangements discussed herein.

As shown, the edge cloud 1910 is established from processing operations among one or more edge locations, such as a satellite vehicle 1941, a base station 1942, a network access point 1943, an on premise server 1944, a network gateway 1945, a central office 1920, or similar networked devices and equipment instances. The edge cloud 1910 is located much closer to the endpoint (consumer and producer) data sources 1960 (e.g., autonomous vehicles 1961, user equipment 1962, business and industrial equipment 1963, video capture devices 1964, drones 1965, smart cities and building devices 1966, sensors and IoT devices 1967, etc.) than the cloud data center 1930.

The edge cloud 1910 is generally defined as involving compute that is located closer to endpoints 1960 (e.g., consumer and producer data sources) than the cloud 1930, such as compute deployed closer to autonomous vehicles 1961, user equipment 1962, business and industrial equipment 1963, video capture devices 1964, drones 1965, smart cities and building devices 1966, sensors and IoT devices 1967, etc. Compute, memory, network, and storage resources that are offered at the entities in the edge cloud 1910 can provide ultra-low or improved latency response times for services and functions used by the endpoint data sources as well as reduce network backhaul traffic from the edge cloud 1910 toward cloud 1930 thus improving energy consumption and overall network usages among other benefits.

Compute, memory, and storage are scarce resources, and generally decrease depending on the edge location (e.g., fewer processing resources being available at consumer end point devices than at a base station or at a central office). However, the closer that the edge location is to the endpoint (e.g., UEs), the more that space and power is constrained. Thus, edge computing, as a general design principle, attempts to minimize the amount of resources needed for network services, through the distribution of more resources which are located closer both geographically and in network access time. In the scenario of a non-terrestrial network, distance and latency may be far to and from the satellite, but data processing may be better accomplished at edge computing hardware in the satellite vehicle rather requiring additional data connections and network backhaul to and from the cloud.

In an example, an edge cloud architecture extends beyond typical deployment limitations to address restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Edge computing is a developing paradigm where computing is performed at or closer to the “edge” of a network, typically through the use of a compute platform implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Likewise, within edge computing deployments, there may be scenarios in services which the compute resource will be “moved” to the data, as well as scenarios in which the data will be “moved” to the compute resource. Or as an example, base station (or satellite vehicle) compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 19, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges. The extension of satellite capabilities within an edge computing network provides even more possible permutations of managing compute, data, bandwidth, resources, service levels, and the like.

Depending on the real-time requirements in a communications context, a hierarchical structure of data processing and storage nodes may be defined in an edge computing deployment involving satellite connectivity. This is especially relevant for applications which require connection via satellite, and the additional latency that trips via satellite may require to the cloud. For example, such a deployment may include local ultra-low-latency processing, regional storage and processing as well as remote cloud datacenter-based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud datacenter.

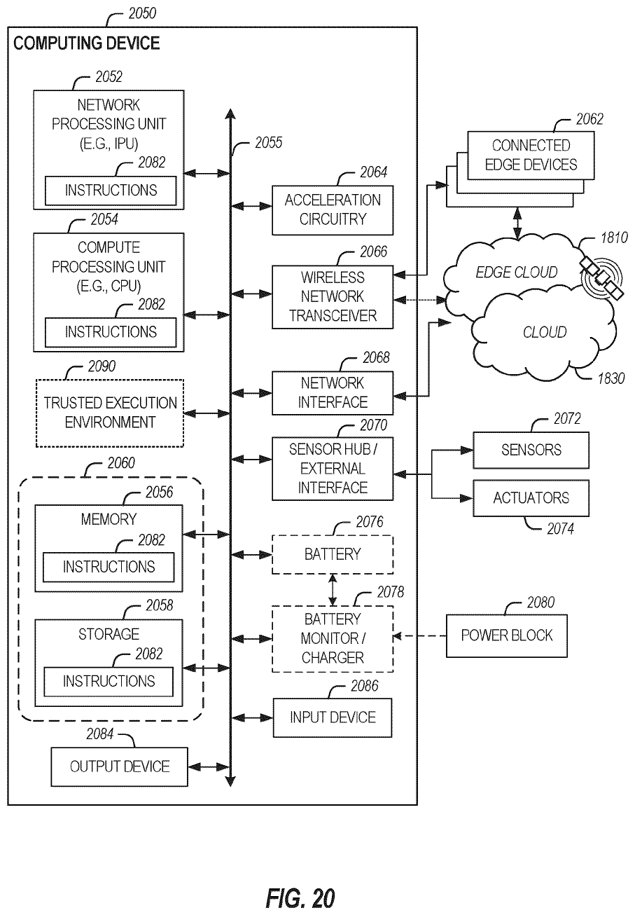

FIG. 20 depicts a block diagram of example components in a computing device 2050 that can operate as a compute processing platform. The computing device 2050 may include any combinations of the components referenced above, implemented as integrated circuits (ICs), as a package or system-on-chip (SoC), or as portions thereof, discrete electronic devices, or other modules, logic, instruction sets, programmable logic or algorithms, hardware, hardware accelerators, software, firmware, or a combination thereof adapted in the computing device 2050, or as components otherwise incorporated within a larger system. Specifically, the computing device 2050 may include processing circuitry comprising one or both of a network processing unit 2052 (e.g., an infrastructure processing unit (IPU) or data processing unit (DPU)) and a compute processing unit 2054 (e.g., a CPU).

The network processing unit 2052 may provide a networked specialized processing unit such as an IPU, DPU, network processor, or other “xPU” outside of the central processing unit (CPU). The processing unit may be embodied as a standalone circuit or circuit package, integrated within an SoC, integrated with networking circuitry (e.g., in a SmartNIC), or integrated with acceleration circuitry, storage devices, or AI or specialized hardware, consistent with the examples above.

The compute processing unit 2054 may provide a processor as a central processing unit (CPU) microprocessor, multi-core processor, multithreaded processor, an ultra-low voltage processor, an embedded processor, or other forms of a special purpose processing unit or specialized processing unit for compute operations.

Either the network processing unit 2052 or the compute processing unit 2054 may be a part of a system on a chip (SoC) which includes components formed into a single integrated circuit or a single package. The network processing unit 2052 or the compute processing unit 2054 and accompanying circuitry may be provided in a single socket form factor, multiple socket form factor, or a variety of other formats.

The processing units 2052, 2054 may communicate with a system memory 2056 (e.g., random access memory (RAM)) over an interconnect 2055 (e.g., a bus). In an example, the system memory 2056 may be embodied as volatile (e.g., dynamic random access memory (DRAM), etc.) memory. Any number of memory modules may be used to provide for a given amount of system memory. A storage 2058 may also couple to the processor 2052 via the interconnect 2055 to provide for persistent storage of information such as data, applications, operating systems, and so forth. In an example, the storage 2058 may be implemented as non-volatile storage such as a solid-state disk drive (SSD). A “memory device” or “storage medium” as used herein may encompass any combination of volatile or non-volatile memory or storage—and thus, may include the system memory 2056, the storage 2058, cache on the processor 2052, among other examples.

The components may communicate over the interconnect 2055. The interconnect 2055 may include any number of technologies, including industry-standard architecture (ISA), extended ISA (EISA), peripheral component interconnect (PCI), peripheral component interconnect extended (PCIx), PCI express (PCIe), Compute Express Link (CXL), or any number of other technologies. The interconnect 2055 may couple the processing units 2052, 2054 to a transceiver 2066, for communications with connected edge devices 2062.

The transceiver 2066 may use any number of frequencies and protocols. For example, a wireless local area network (WLAN) unit may implement Wi-Fi® communications in accordance with the Institute of Electrical and Electronics Engineers (IEEE) 802.11 standard, or a wireless wide area network (WWAN) unit may implement wireless wide area communications according to a cellular, mobile network, or other wireless wide area protocol. The wireless network transceiver 2066 (or multiple transceivers) may communicate using multiple standards or radios for communications at a different range. A wireless network transceiver 2066 (e.g., a radio transceiver) may be included to communicate with devices or services in the edge cloud 1910 or the cloud 1930 via local or wide area network protocols.

The communication circuitry (e.g., transceiver 2066, network interface 2068, external interface 2070, etc.) may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, Matter®, low-power wide-area network (LPWAN) or low-power wide-area (LPWA) protocols, etc.) to effect such communication. Given the variety of types of applicable communications from the device to another component or network, applicable communications circuitry used by the device may include or be embodied by any one or more of components 2066, 2068, or 2070. Accordingly, in various examples, applicable means for communicating (e.g., receiving, transmitting, etc.) may be embodied by such communications circuitry.

The computing device 2050 may include or be coupled to acceleration circuitry 2064, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 2055 may couple the processing units 2052, 2054 to a sensor hub or external interface 2070 that is used to connect additional devices or subsystems. The devices may include sensors 2072, such as accelerometers, level sensors, flow sensors, optical light sensors, camera sensors, temperature sensors, global navigation system (e.g., GPS) sensors, pressure sensors, pressure sensors, and the like. The hub or interface 2070 further may be used to connect the edge computing device 2050 to actuators 2074, such as power switches, valve actuators, an audible sound generator, a visual warning device, and the like.

In some optional examples, various input/output (I/O) devices may be present within or connected to, the edge computing device 2050. For example, a display or other output device 2084 may be included to show information, such as sensor readings or actuator position. An input device 2086, such as a touch screen or keypad may be included to accept input. An output device 2084 may include any number of forms of audio or visual display, including simple visual outputs such as LEDs or more complex outputs such as display screens (e.g., LCD screens), with the output of characters, graphics, multimedia objects, and the like being generated or produced from the operation of the edge computing device 2050.

A battery 2076 may power the edge computing device 2050, although, in examples in which the edge computing device 2050 is mounted in a fixed location, it may have a power supply coupled to an electrical grid, or the battery may be used as a backup or for temporary capabilities. A battery monitor/charger 2078 may be included in the edge computing device 2050 to track the state of charge (SoCh) of the battery 2076. The battery monitor/charger 2078 may be used to monitor other parameters of the battery 2076 to provide failure predictions, such as the state of health (SoH) and the state of function (SoF) of the battery 2076. A power block 2080, or other power supply coupled to a grid, may be coupled with the battery monitor/charger 2078 to charge the battery 2076.

In an example, the instructions 2082 on the processing units 2052, 2054 (separately, or in combination with the instructions 2082 of the machine-readable medium 2060) may configure execution or operation of a trusted execution environment (TEE) 2090. In an example, the TEE 2090 operates as a protected area accessible to the processing units 2052, 2054 for secure execution of instructions and secure access to data. Other aspects of security hardening, hardware roots-of-trust, and trusted or protected operations may be implemented in the edge computing device 2050 through the TEE 2090 and the processing units 2052, 2054.

The edge computing device 2050 may be a server, appliance computing devices, and/or any other type of computing device with the various form factors discussed above. For example, the edge computing device 2050 may be provided by an appliance computing device that is a self-contained electronic device including a housing, a chassis, a case, or a shell.

In an example, the instructions 2082 provided via the memory 2056, the storage 2058, or the processing units 2052, 2054 may be embodied as a non-transitory, machine-readable medium 2060 including code to direct the processor 2052 to perform electronic operations in the edge computing device 2050. The processing units 2052, 2054 may access the non-transitory, machine-readable medium 2060 over the interconnect 2055. For instance, the non-transitory, machine-readable medium 2060 may be embodied by devices described for the storage 2058 or may include specific storage units such as optical disks, flash drives, or any number of other hardware devices. The non-transitory, machine-readable medium 2060 may include instructions to direct the processing units 2052, 2054 to perform a specific sequence or flow of actions, for example, as described with respect to the flowchart(s) and block diagram(s) of operations and functionality discussed herein. As used herein, the terms “memory device”, “storage device”, “machine-readable medium”, “machine-readable storage”, “computer-readable storage”, and “computer-readable medium” are interchangeable.

In further examples, a machine-readable medium also includes any tangible medium that is capable of storing, encoding, or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers.

In further examples, a software distribution platform (e.g., one or more servers and one or more storage devices) may be used to distribute software, such as the example instructions discussed above, to one or more devices, such as example processor platform(s) and/or example connected edge devices noted above. The example software distribution platform may be implemented by any computer server, data facility, cloud service, etc., capable of storing and transmitting software to other computing devices. In some examples, the providing entity is a developer, a seller, and/or a licensor of software, and the receiving entity may be consumers, users, retailers, OEMs, etc., that purchase and/or license the software for use and/or re-sale and/or sub-licensing.

In some examples, the instructions are stored on storage devices of the software distribution platform in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions stored in the software distribution platform are in a first format when transmitted to an example processor platform(s). In some examples, the first format is an executable binary in which particular types of the processor platform(s) can execute. However, in some examples, the first format is uncompiled code that requires one or more preparation tasks to transform the first format to a second format to enable execution on the example processor platform(s). For instance, the receiving processor platform(s) may need to compile the computer readable instructions in the first format to generate executable code in a second format that is capable of being executed on the processor platform(s). In still other examples, the first format is interpreted code that, upon reaching the processor platform(s), is interpreted by an interpreter to facilitate execution of instructions.

In the examples above, many references were provided to low-earth orbit (LEO) satellites and constellations. However, it will be understood that the examples above are also relevant to many forms of middle-earth orbit satellites and constellations, geosynchronous orbit satellites and constellations, and other high altitude communication platforms such as balloons. Thus, it will be understood that the techniques discussed for LEO network settings are also applicable to many other network settings.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1.-20. (canceled)

21. A computing system, comprising:
processing circuitry; and
a memory device including instructions embodied thereon, wherein the instructions, which when executed by the processing circuitry, configure the processing circuitry to perform operations that:
obtain orbital position data for a low-earth orbit satellite vehicle (SV), the low-earth orbit SV to operate as a serving transmission and reception point (TRP) to a user equipment (UE);
determine a timing measurement of at least one communication between the serving TRP and the UE; and
calculate a geographic location of the UE based on the orbital position data and the timing measurement.

22. The computing system of claim 21, wherein the instructions further configure the processing circuitry to perform operations that:
determine an expected timing measurement of the at least one communication between the TRP and the UE, based on the orbital position data; and
verify the geographic location of the UE based on a comparison of the timing measurement with the expected timing measurement.

23. The computing system of claim 22, wherein the instructions further configure the processing circuitry to perform operations that:
obtain UE geographic position data, based on coordinates obtained at the UE from a global navigation satellite system (GNSS), wherein the coordinates provide an initial position to calculate a timing advance for the UE;
wherein the geographic location of the UE is further verified based on a comparison of the UE geographic position data with the calculated geographic location.

24. The computing system of claim 21, wherein the instructions further configure the processing circuitry to perform operations that:
perform an operation in a core network (CN) of a 3GPP network, based on verification of the geographic location of the UE;
wherein operations to calculate the geographic location of the UE and to verify the geographic location are triggered by the CN.

25. The computing system of claim 21, wherein the at least one communication provides a reference signal, and wherein the timing measurement is a reference signal time difference between a receipt and a transmission of the reference signal from the UE.

26. The computing system of claim 25, wherein the reference signal is scheduled according to a Multi-Round Trip Time (mRTT) positioning method.

27. The computing system of claim 21, wherein the orbital position data is obtained from a third-party data source of satellite positioning data.

28. The computing system of claim 21, wherein the instructions further configure the processing circuitry to perform operations that:
obtain additional orbital position data for at least two other low-earth orbit SVs to operate as neighbor TRPs to the serving TRP; and
determine additional timing measurements of at least one communication between each of the neighbor TRPs and the UE;
wherein the geographic location of the UE is further calculated based on the additional orbital position data and the additional timing measurements.

29. The computing system of claim 21, wherein the computing system operates as a Location Management Function (LMF) or Access and Mobility Management Function (AMF) of a 3GPP network.

30. The computing system of claim 29, wherein the instructions further configure the processing circuitry to perform operations that:
determine an expected geographic location of the UE based on the orbital position data; and
control an operation in the 3GPP network based on a comparison of the geographic location of the UE with the expected geographic location of the UE.

31. A method for non-terrestrial network (NTN)-assisted location calculation for a terrestrial user equipment (UE), performed by processing circuitry of a computing system, the method comprising:
receiving orbital position data for a low-earth orbit satellite vehicle (SV), the low-earth orbit SV to operate as a serving transmission and reception point (TRP) to a user equipment (UE);
determining a timing measurement of at least one communication between the serving TRP and the UE; and
calculating a geographic location of the UE based on the orbital position data and the timing measurement.

32. The method of claim 31, further comprising:
determining an expected timing measurement of the at least one communication between the TRP and the UE, based on the orbital position data; and
verifying the geographic location of the UE based on a comparison of the timing measurement with the expected timing measurement.

33. The method of claim 32, further comprising:
obtaining UE geographic position data based on coordinates obtained at the UE from a global navigation satellite system (GNSS), wherein the coordinates provide an initial position to calculate a timing advance for the UE;
wherein the geographic location of the UE is further verified based on a comparison of the UE geographic position data with the calculated geographic location.

34. The method of claim 31, further comprising:
performing an operation in a core network (CN) of a 3GPP network, based on verification of the geographic location of the UE;
wherein operations to calculate the geographic location of the UE and to verify the geographic location are triggered by the CN.

35. The method of claim 31, wherein the at least one communication provides a reference signal, and wherein the timing measurement is a reference signal time difference between a receipt and a transmission of the reference signal from the UE.

36. The method of claim 35, wherein the reference signal is scheduled according to a Multi-Round Trip Time (mRTT) positioning method.

37. The method of claim 31, wherein the orbital position data is obtained from a third-party data source of satellite positioning data.

38. The method of claim 31, further comprising:
obtaining additional orbital position data for at least two other low-earth orbit SVs to operate as neighbor TRPs to the serving TRP; and
determining additional timing measurements of at least one communication between each of the neighbor TRPs and the UE;
wherein the geographic location of the UE is further calculated based on the additional orbital position data and the additional timing measurements.

39. The method of claim 31, wherein the computing system operates as a Location Management Function (LMF) or Access and Mobility Management Function (AMF) of a 3GPP network.

40. The method of claim 39, further comprising:
determining an expected geographic location of the UE based on the orbital position data; and
controlling an operation in the 3GPP network based on a comparison of the geographic location of the UE with the expected geographic location of the UE.
